(19) United States
(12) Patent Application Publication
(10) Pub. No.: US 2011/0046974 A1
(43) Pub. Date: Feb. 24, 2011

(54) SYSTEMS AND METHODS FOR MONITORING AND REPORTING LAB RESULTS

(76) Inventors: Greg Burks, Albuquerque, NM (US); Paul Beyer, Redwood City, CA (US); Jeff Vizethann, Cornwall, NY (US); Olivier Gindraux, Burlingame, CA (US)

Correspondence Address: WILSON, SONSINI, GOODRICH & ROSATI, 650 PAGE MILL ROAD, PALO ALTO, CA, 94304-1050, US

(21) Appl. No.: 12/860,571

(22) Filed: Aug. 20, 2010

Related U.S. Application Data
(60) Provisional application No. 61/274,910, filed on Aug. 21, 2009.

(51) Int. Cl. G06Q 50/00; G06Q 10/00; G06Q 90/00; G06F 3/048

(52) U.S. Cl. 705/2; 705/500; 715/764

(57) ABSTRACT

The invention provides systems and methods for monitoring and/or reporting laboratory data. One or more laboratory facility may communicate with a data management center. Medical laboratory data, which may include renal data, may be provided to the data management center. In some instances, some of the data from a laboratory facility may be compared to a reference value, or a goal to assess the performance of the laboratory facility. Data may be displayed to a user of the system in a report. Financial tools may also be provided to assess costs associated with bundling various laboratory tests.

### CROSS-REFERENCE

This application claims the benefit of U.S. Provisional Application No. 61/274,910, filed Aug. 21, 2009, which application is incorporated herein by reference in its entirety.

### BACKGROUND OF THE INVENTION

Laboratory facilities have been used to perform tests and analyze medical data. However, a need exists for systems and methods of monitoring and reporting lab results, especially with respect to renal laboratory data.

### SUMMARY OF THE INVENTION

One aspect of the invention may be directed to a system for managing medical laboratory data. The system may include a telecommunications network; at least one remote laboratory facility with laboratory equipment for gathering medical laboratory data from a plurality of subjects; and a data management center for receiving medical laboratory data from the at least one remote laboratory facility via the telecommunications network, wherein the data management center compares the received medical laboratory data to a reference medical laboratory data to assess performance of the at least one remote laboratory facility.

Another aspect of the invention may be directed to a method for managing medical laboratory data, said method comprising: receiving medical data from at least one laboratory facility; establishing at least one laboratory result goal for the at least one laboratory facility; and determining, based on the medical data, whether the at least one laboratory result goal was met by the at least one laboratory facility.

A graphical user interface for facility performance assessment may be provided in accordance with another aspect of the invention. The graphical user interface may include a list with a plurality of laboratory result types; a plurality of comparison methods, wherein each comparison method is visually mapped to the corresponding laboratory result type; a plurality of goal values, wherein each goal value is visually mapped to the corresponding laboratory result type; and a plurality of acceptable range values, wherein the acceptable range values denote an acceptable range for a laboratory result as compared to the corresponding goal values, and wherein each acceptable range value is visually mapped to the corresponding laboratory result type.

An aspect of the invention may also be directed to a graphical user interface for performing bundling analytics for Medicare bundling. The graphical user interface may comprise a list of one or more tests to be included within a medical service bundle; at least one cost value for the test, visually mapped to the test; a frequency selection zone for the test, indicating how often the test is to be performed; and an average cost per patient estimated over a selected time period.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a server communicating with a plurality of client computers over a network.

FIG. 2 shows a system for managing medical laboratory data.

FIG. 3 shows an example of a reports listing page for a laboratory data management software.

FIG. 4 shows an example of a user interface that may appear when a user is creating or editing a report.

FIGS. 5A and 5B show examples of a report display for distribution and trend.

FIG. 6 shows an example of an environmental result trend.

FIG. 7 shows another example of a report format for a facility report card.

FIG. 8 provides an example of a specimen uniformity performance evaluation report.

FIG. 9 provides an example of a patient detail list page.

FIG. 10 shows a user interface where a group of patients may be searched.

FIG. 11 provides an example of a patient that may be provided as a result of a patient inquiry.

FIG. 12 shows an example of a list of patients that may be provided as a result of a patient inquiry.

FIG. 13 shows a list of patients with a visual indicator for trends.

FIG. 14 shows an example of a graphical trend page.

FIG. 15 shows a group manager page.

FIG. 16 shows a user interface for creating a new goal.

FIG. 17 shows another example of a goal manager.

FIG. 18 provides an example of an expanded view of a goal for a particular test.

FIG. 19 provides a user interface for editing a goal.

FIG. 20 shows an additional view of a goal editing interface.

FIG. 21 shows a goal manager interface which may also include an option to print a goal summary.

FIG. 22 shows an example of a goal summary that may be printed.

FIG. 23 shows an example of a work flow process when a user is copying a report from one facility to another facility.

FIGS. 24A and 24B show lists of reports may be filtered and provided to the user.

FIG. 25 shows how a report may also be filtered by company.

FIGS. 26A and 26B provide examples of a copying report template.

FIG. 27 shows how a financial tool may be selected from a menu.

FIG. 28 shows an example of a financial bundling report.

FIG. 29 provides an overview of a financial tool.

FIG. 30 shows an example of a laboratory bundling page.

FIG. 31 shows an example of a bundling calculator page.

FIG. 32 shows an example of frequency factor values that may be provided for given frequencies.

FIG. 33 shows an example of a facility average cost per patient report using Medicare bundling.

FIG. 34 provides an estimated facility average cost per patient report.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for monitoring and reporting laboratory results. Various aspects of the invention described herein may be applied to any of the particular applications set forth below or for any other types of user interfaces and displays, or renal data management applications. The invention may be applied as a standalone system or method, or as part of an integrated software package, such as a medical and/or laboratory data management package or application. It shall be understood that different aspects of the invention can be appreciated individually, collectively, or in combination with each other.

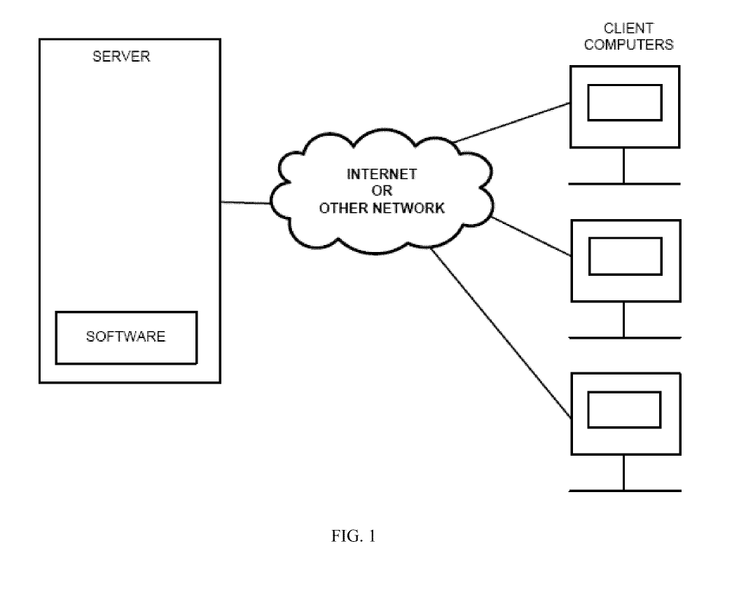

A user interface provided in accordance with the invention herein may be displayed across a network such as the Internet. For example, as shown in FIG. 1, an implementation may include a client computer comprising a video display with at least one display page comprising data. The data may include medical and/or laboratory data, which may include data such as renal laboratory data such as medication and dialysis data (e.g., medication, dialysis, diet, and additional orders, physician electronic signatures, medication labels), visit and treatment logs (e.g., various visit or treatment information, patent assessments, patient notes, access history/usage), and any associated interfacing data (e.g., machine data, or billing data), or so forth. In some embodiments, such data may be collected from one or more measurement or sensing devices at a clinic or laboratory. Such measurement or sensing devices may collect data from a subject or from a sample obtained from a subject. In some embodiments, data may be entered manually or collected automatically.

Any such medical and/or laboratory data may be provided on any level, such as individual patient level, groups (which may be made up of patients or organized in any other manner), laboratory level, organization level (e.g., an organization or entity may own or operate one or more laboratories), or system level (which may include all laboratory facilities and/or organizations that may be interacting with a data management center).

Any discussion herein relating to medical, renal, or laboratory data may relate to one another. Thus any discussion of laboratory data may apply to medical or renal data, and vice versa. Similarly, any discussion of any of the aforementioned types of data may relate to any other types of aforementioned data. Furthermore, any discussion herein may also be applied to any other types of data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which may be transmitted from a server over a network to a client computer, which can store it in memory. A client computer may receive non-transitory computer readable media, which may contain instructions, logic, data, or code that may be stored in persistent or temporary memory of the client computer, or may somehow affect or initiate action by a client computer. Similarly, one or more servers may communicate with one or more client computers across a network, and may transmit computer files residing in memory. The network, for example, can include the Internet or any network for connecting one or more clients to one or more servers.

Any discussion of a client computer may also apply to any type of networked device, including but not limited to a personal computer, server computer, or laptop computer; personal digital assistants (PDAs) such as a Palm-based device or Windows CE device; phones such as cellular phones or location-aware portable phones (such as GPS); a roaming device, such as a network-connected roaming device; a wireless device such as a wireless email device or other device capable of communicating wireless with a computer network; or any other type of network device that may communicate over a network and handle electronic transactions. Any discussion of any device mentioned may also apply to other devices.

At a client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Any computer readable media with logic, code, data, instructions, may be used to implement any software or steps or methodology. Where a network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, tabs, scroll bars, buttons, icons, menus, fields, and hyperlinks, and well known features such as a “point and click” interface. Pointing to and clicking on a graphical user interface button, icon, menu option, or hyperlink also is known as “selecting” the button, icon, option, or hyperlink. Additionally, a “point and gesture” interface may be utilized, such as a hand-gesture driven interface. Furthermore, a touchscreen interface may be utilized, where touching a visual object may constitute selecting the object. Any other interface for interacting with a graphical user interface may be utilized. A display page according to the invention also may incorporate multimedia features.

A user interface may be displayed on a video display and/or display page. A server and/or client computer may have access to laboratory data management software. A user interface may be used to display or provide access to medical or laboratory data.

For example, a user interface may be provided for a web page or for an application. An application may be accessed remotely or locally. A user interface may be provided for a software program, gadget, widget, tool, plug-in, or any other type of object, application, or software. For example, a user at a client computer may be able to access a display page for a laboratory data management software program. The laboratory data management software may provide functionality that monitor and/or report laboratory data (e.g., renal or other medical data) to the user.

Any of the client or server devices described may have tangible computer readable media with logic, code, or instructions for performing any actions described herein or running any algorithm. The devices with such computer readable media may be specially programmed to perform the actions dictated by the computer readable media. In some embodiments, the devices may be specially programmed to perform one or more tasks relating to renal laboratory data, financial, or organizational management. In some embodiments, the devices may communicate with or receive data collected from one or more measurement or sensing device, which may collect physiological data from a subject or from a sample collected from a subject.

System Structure

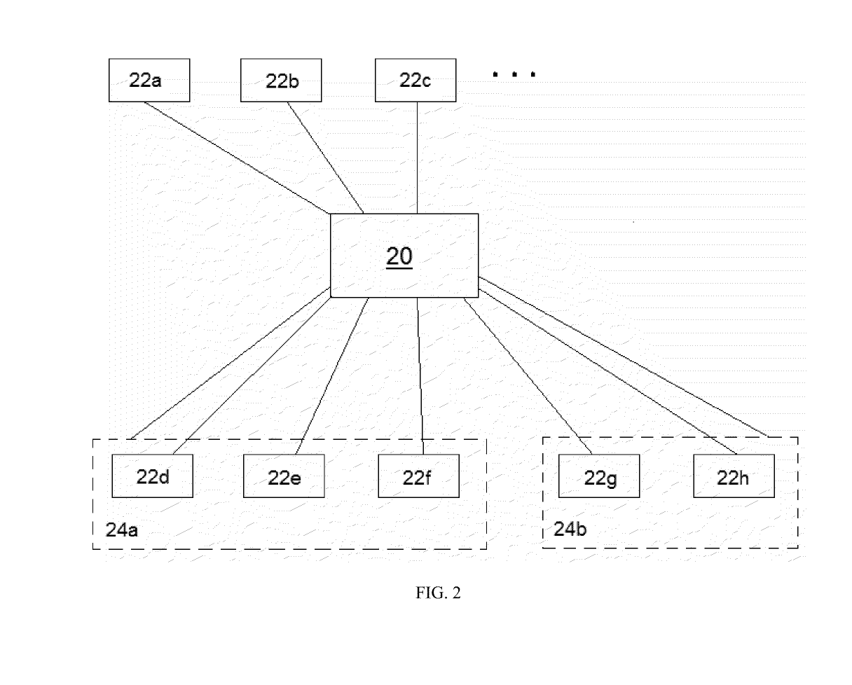

FIG. 2 shows a system for managing medical laboratory data. Such a system may include a telecommunications network, a remote laboratory facility (e.g., 22a, 22b, 22c, 22d, 22e, 22f, 22g, 22h), and a data management center 20. In some embodiments, one, two, or more laboratory facilities may communicate with the data management center over the telecommunications network. As previously mentioned, the telecommunications network may be any network, such as the Internet, a local area network, or a wireless communications network. Any communications may occur over a network or directly. Any communication may be via a wired connection or may occur wirelessly.

The system may include at least one remote laboratory facility (e.g., 22a, 22b, 22c, 22d, 22e, 22f, 22g, 22h). One, two, three, or more laboratory facilities may be provided with laboratory equipment for gathering medical laboratory data from one or more subjects. A subject may be a patient, clinical test subject, person, human, or animal. Any discussion herein of patients or subjects, may refer to any type of subject. Remote laboratory facilities may or may not be associated with an entity (e.g., 24a, 24b). For example, an entity may be an organization, a company, a corporation, a partnership, or some form of association between one or more labs. For example, some laboratory facilities (e.g., 22a, 22b, 22c) may not be associated with an entity, while some laboratory facilities (e.g., 22d, 22e, 22f) may be part of a first group (e.g., 24a) and some other laboratory facilities (e.g., 22g, 22h) may be associated with another entity (e.g., 24b).

The system may also include one or more data management center 20 for receiving medical laboratory data from the at least one remote laboratory facility via the telecommunications network. The data management center may or may not provide medical laboratory data to a facility. In some embodiments, some data may be shared between one or more facility. Sharing may occur via the data management center. In some instances, only restricted sharing may occur. For example, only a limited subset of data may be shared. Alternatively, data may only be shared between facilities affiliated with same entity. The medical laboratory data may be any type of medical or laboratory data, including but not limited to patient data, clinical data, test data, or any data relating renal or dialysis data. Renal or dialysis data may be provided from one or more subjects associated with a laboratory facility.

The data management center may compare the received medical laboratory data to a reference medical laboratory data to assess performance of the at least one remote laboratory facility. The reference medical laboratory data may be based on at least one of the following: another laboratory facility, a mathematical calculation from the data management center based on a plurality of laboratory facilities, or generated theoretical reference data from the data management center. For example, a first laboratory facility's medical data may be compared to another second laboratory facility's medical data. In such a way, the first laboratory facility's performance may be assessed with respect to the second laboratory facility's performance. The first laboratory facility's medical data may also be compared to a mathematical calculation based on a plurality of laboratory facilities (e.g., the mean of a group of laboratory facility data, or some other statistical analysis of a group of laboratory facilities). Similarly, the laboratory facility data may be compared to any theoretical reference data, which may be made based on self-defined goals, policy-based goals, or any other value.

A system for monitoring and reporting laboratory results may enable facilities and/or entities the flexibility to set their own goals and ranges, create their own reports, and create groupings. Users of the system can build queries for tests, and drill down on reports to get details. Users may utilize a laboratory data management software to perform these functions.

In some embodiments, a data management center may have a server that may provide access to the laboratory data management software to users at remote facilities. In some instances, a remote facility may have a server and/or a client computer that may have the laboratory data management software on a local memory, or that may access the software across a network. A data management center may also have one or more server and/or client computer that may enable users internal to the data management center to locally or remotely access the laboratory data management software.

Similarly, a method for managing medical laboratory data may be provided. The method may include the steps of receiving medical data from at least one laboratory facility, establishing at least one laboratory result goal for the facility, and determining, based on the medical data, whether the laboratory result goal has been met by the facility. Reports may be generated to assess the performance of the facility, whether it is with respect to a goal, or whether it analyzes medical data over time. The medical data may be received at a remote command center via a telecommunications network (e.g., Internet, wireless communications network, LAN).

In some embodiments, the goal may include an acceptable range of values for the laboratory results. The laboratory results may be from one or more subjects at a laboratory facility. Further discussions of goals are provided herein.

Reports

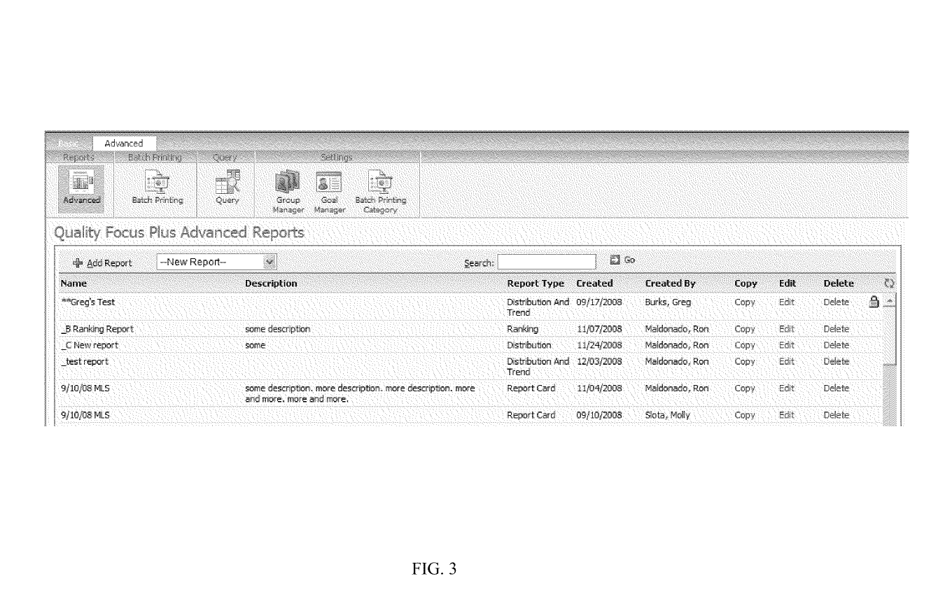

The data management center may generate a report. In some embodiments, the report may be based on the comparison of the received medical laboratory data with the reference medical laboratory data. FIG. 3 provides an example a user interface for a laboratory data management software that may show some of the reports that may be generated. For examples, a reports listing page may include the name of a report or test, a description of the report or test, report type, date created, who created the report, and additional functionality associated with the report (e.g., copy, edit, delete). Some examples of available report types may include Distribution, Distribution and Trend, Quarterly Trend, Ranking, Report Card, Report Card Detail, Rolling Patient Detail, and Trend. Further description of possible report types may include:
SLS Company Quarterly Distribution Report—Displays a bar distribution graph of patient data by corporate specific outcome ranges
SLS Company Quarterly Trend Report—Line graph for four sequential quarters of data. Displays the percentage of patients meeting corporate specific goals.
SLS Facility Monthly Distribution and Trend Report—Displays a bar distribution graph for selected month and line graph for the last 12 months of data. Displays the percentage of patients meeting specific goals
SLS Facility Monthly Distribution Report—Displays a bar distribution graph for the selected month. Displays the percentage of patients meeting specific goals.
SLS Facility Monthly Trend Report—Line graph for the last 12 months of data. Displays the percentage of patients meeting specific goals.
SLS Facility Patient Detail Report—Displays all patients who during any month of the quarter have a value that meets the search criteria.
SLS Facility Quarterly Distribution and Trend Report—Displays a bar distribution graph for selected quarter and line graph for the last 12 months of data. Displays the percentage of patients meeting specific goals
SLS Facility Quarterly Distribution Report—Displays a bar distribution graph for selected quarter. Displays the percentage of patients meeting specific goals.
SLS Facility Quarterly Trend Report—Line graph for the selected quarter. Displays the percentage of patients meeting specific goals.
SLS Facility Report Card—Reports in the goal and percentage of patients meeting goal for all lab indicators.
SLS Facility Report Card Detailed—Detailed information on percentage of patients meeting goals for all lab indicators over 12 months with ability to drill down to patient detail report.
SLS Physician Quarterly Distribution Report—Displays a bar distribution graph by specific outcome ranges over a three month period.
SLS Physician Quarterly Trend Report—For facility's physicians (with facility login) or company's physicians (with corporate login). Line graph for 4 sequential quarters of data. Displays the percentage of patients meeting corporate goals.
SLS Rolling Average Report—Patient rolling average for selected test within a given time period.

The reports may be listed on the reports listing page in any matter. For example, they may be provided as a vertical list, a horizontal list, a chart format, or any other type of visual format. The reports may be ordered in any matter (e.g., alphabetically by name, by type, by date created, by date last accessed, by creator) or may be sortable so that the user can sort by a desired category. The report list may enable a user to take an action with a report, such as copying, editing, or deleting the report.

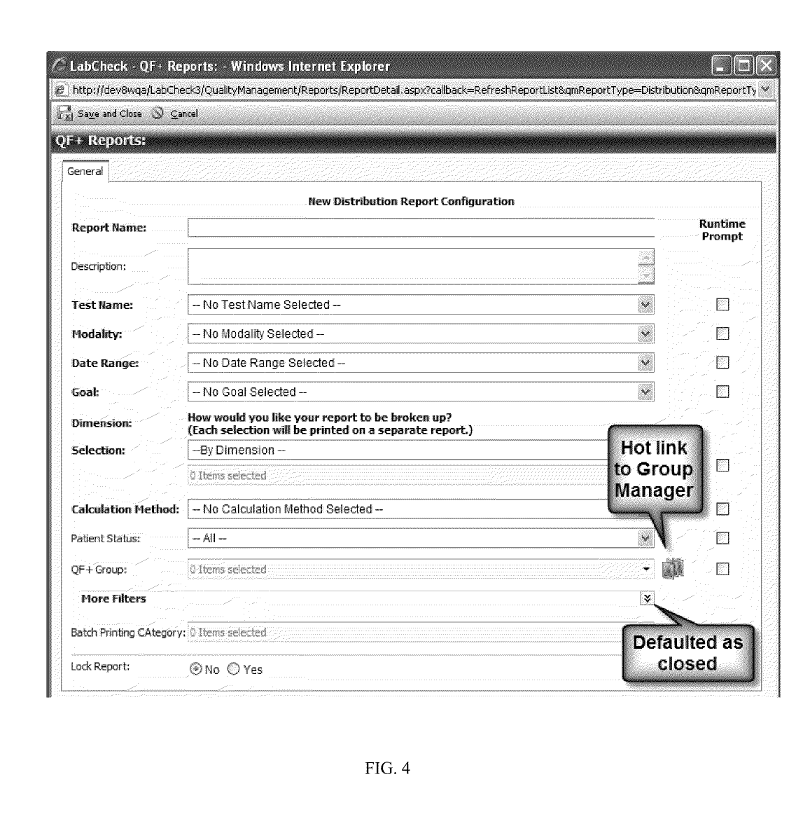

A report's content and/or format may be customized by a user of the laboratory data management software. FIG. 4 shows an example of a user interface that may appear when a user is creating or editing a report. In some embodiments, a new report screen may appear as a popup. The new report screen may overlay part of an existing view or replace an existing view. The new report screen may also appear adjacent to the existing view or may be displayed in a new window.

In some instances, certain fields of a new report screen may be required, while others may be optional. The required fields may be visually emphasized. For example, as shown in FIG. 4, the required fields may appear bolded. Some examples of fields that may be included are report name, a description of the report, a test name, a modality, date range, goal, dimension, selection, calculation method, patient status, groups, more filters, batch printing category and whether to lock the report. Dimension may be used to define how a user wants to slice up data. Several examples of dimensions may include, facility, nephrologist, schedule, days in dialysis, age, gender, race, or diabetic status. Thus, a user may customize how the user wants the report data to be organized.

The new report screen may also include an option to select a runtime prompt. Selecting a runtime prompt may allow a selection to be chosen during the run time of the report, rather than being fixed on the report template. Zero, one, two or more selections may be made for the runtime prompt (e.g., any number of the runtime prompt boxes may be checked off). Checking off a runtime prompt may allow a user to choose, for example, a different test, modality, date range from a drop-down box when running the report. This may enable a user to set some parameters of a report, while allowing flexibility at runtime. Thus, a user may be able to choose or create a report template and one or more report parameters.

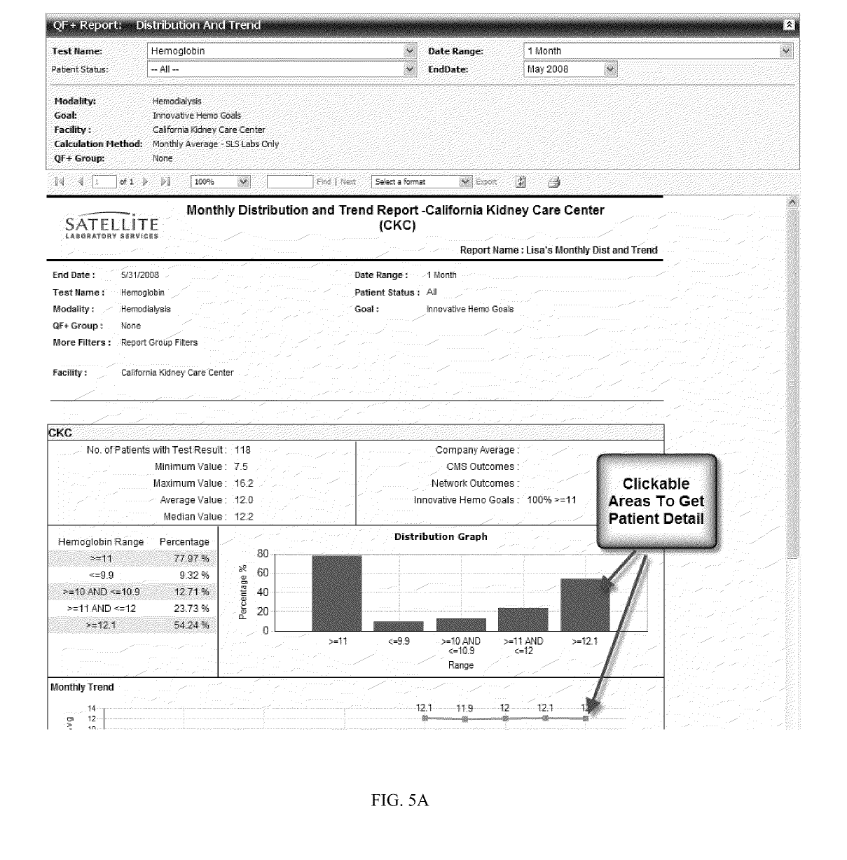

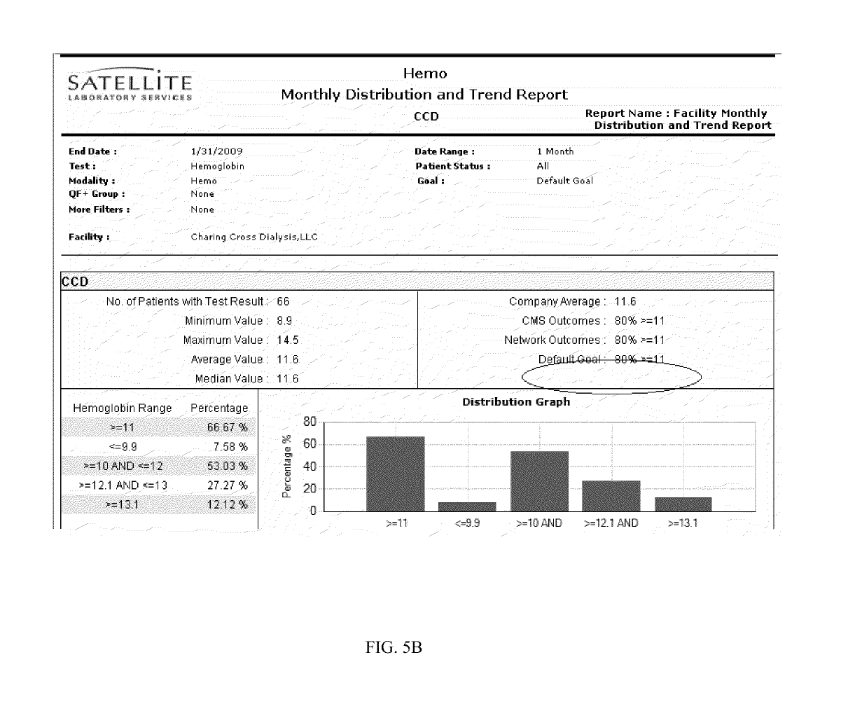

FIG. 5A shows an example of a report display (e.g., for distribution and trend). The top of a user interface showing the report may include parameters that a user may select from or adjust to determine what to view. This may allow a user to navigate between different reports, or may adjust the report that the user may be viewing. For example, a user may be able to select a test name, date range, patient status, and end date. In other embodiments, other parameters may be selected and selectable. Based on the parameter selected, a report may be generated.

The report may include information about a laboratory facility. In alternate embodiments, reports may also be generated for the patient level, group level, or entity (e.g., company) level. The report may include summary information such as end date, date range, test name, patient status, modality, goal, group, whether there are other filters, and facility name. The report may also show information about patients, such as the number of patients, and statistical information about values, such as minimum values, maximum values, average values, median values, and additional information such as company average, CMS outcomes, network outcomes, and goals. The report may also include specific medical laboratory data (e.g., hemoglobin ranges and how they break down).

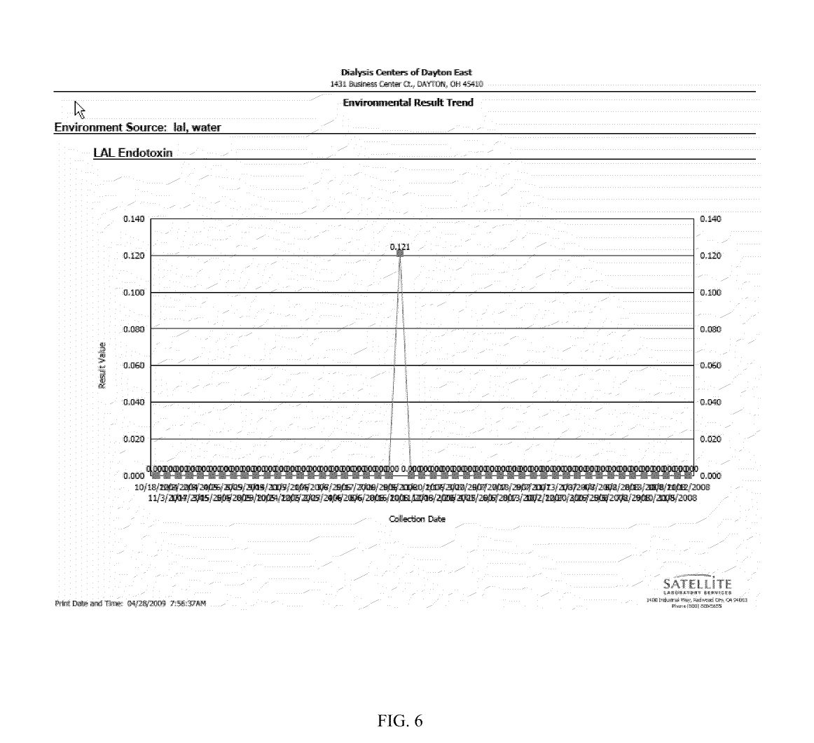

Graphs may be provided to illustrate the medical laboratory data. For example, graphs (e.g., bar graphs, line graphs, pie charts, etc.) may show distribution data and/or trend data. Distribution data may break laboratory medical data into distinct value ranges. In some embodiments, a user may specify how many ranges (aka distribution segments) may be desired (e.g., 3, 4, 5, 6, 7, etc.). FIG. 6 shows an example of an environmental result trend. Preferably, the environmental result trend may be limited to display only the last 12 collection dates (or any other limited number of collection dates, to maintain readability and not have too many dates overlap one another). Any trends displayed may be limited in time.

FIG. 5B shows another example of a distribution and trend report. The area indicated by the circle may be where a user may be able to access various statistical features for the data. Areas of the distribution and trend report may be selectable (e.g., clickable) by the user to drill down to further details or related information. For example, the statistical report may be used to provide a benchmark/statistic for users that are current and relevant. In some instances, the statistical report may be more up to date and/or relevant than the benchmarks of CMS outcomes and network outcomes. For example, a statistic report may be for “YEAR 4^{th} QTR” where the year and quarter may be determined by the last completed quarter (e.g., 1^{st} qtr=January-March, 2^{nd} qtr=April-June, 3^{rd} qtr=July-September, 4^{th} qtr=October-December). The statistical report may obtain the first value for a month for each patient. A quarterly average is obtained for each patient using the first value of the month. The quarterly average may be measured against a given goal to evaluate if that patient met goal. A percentage of patients meeting goal is then calculated.

### Example

| Patient | Jan | Feb | March | Q Avg | Met Goal |
|---|---|---|---|---|---|
| A | 3.50 | 4.10 | 4.10 | 3.90 | 0 |
| B | 3.90 | 4.00 | 4.00 | 3.97 | 0 |
| C | 3.50 | 3.70 | 3.50 | 3.57 | 0 |
| D | 4.10 | 4.20 | 4.30 | 4.20 | 1 |
| E | 3.60 | 3.70 | 4.00 | 3.77 | 0 |
| F | 3.40 | | 4.10 | 3.75 | 0 |
| G | 3.60 | | | 3.60 | 0 |

Total Results used 7
Total Meeting Goal 1
% Meeting goal of 4.0 14.29%

A given goal may be provided for each test. If a goal is not given for a test, that statistic may be reported as N/A for that test (Or reported however the Network and CMS outcomes is reported when there is no data). Alternatively, an area could be built in the future to maintain this list of goals. Such statistics need not be calculated each time the user runs the report and may instead be calculated at the end of each quarter and used on the report. Only the most current completed quarter may be displayed and the most recent completed quarter may replace the previous one's data.

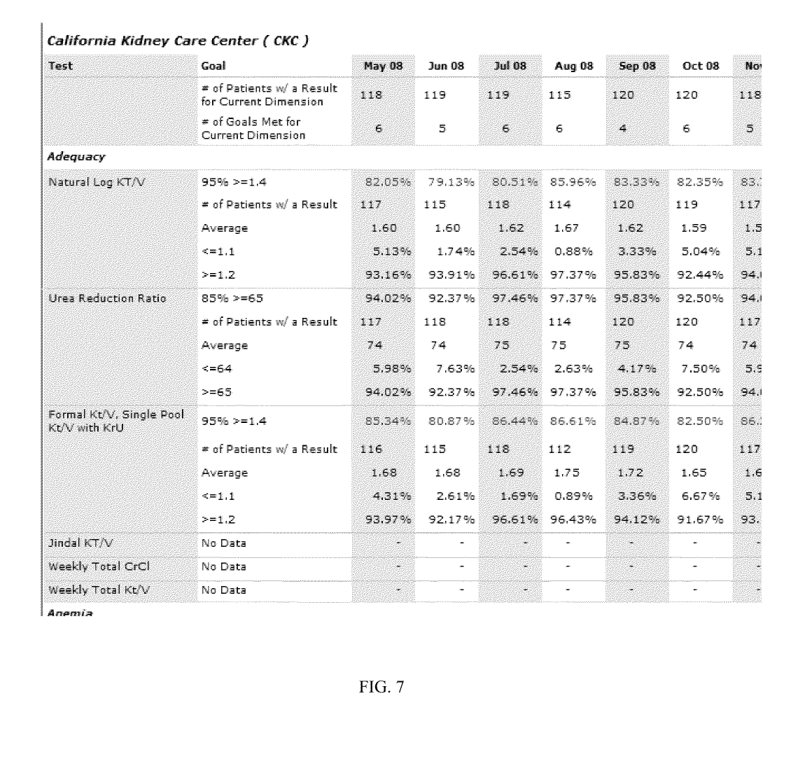

FIG. 7 shows another example of a report format (e.g., a facility report card format). In some instances, a report may have a chart format. Such reports may include a test, a goal, and results for the test over time. The time may be broken up into any units of time, whether it be daily, weekly, monthly, quarterly, yearly, or so forth. The time may be displayed chronologically, or reverse chronologically. The results for a test may be visually mapped to the test (e.g., same region, row or column). The results may also be visually mapped to the corresponding time of the results (e.g., same region, row or column). The report may determine how many results for the facility actually met the defined goals. Thus, a comparison may be provided over time on the facility performance, and a user may view the results for specific tests.

The tests may be broken up into test categories. In some embodiments, information may be provided on whether the facility met its goal on an individual test level, a test category level, or overall facility level. In some instances, when a facility does or does not meet its goal, the results for meeting or not meeting the goal may be visually emphasized.

Goal based applications will be discussed further herein.

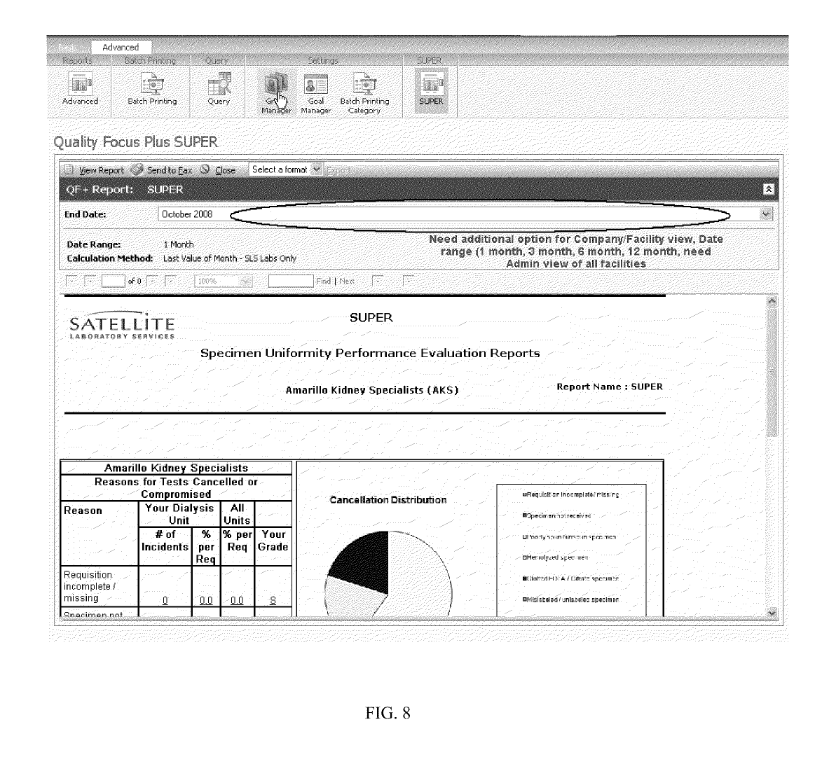

FIG. 8 provides an example of a specimen uniformity performance evaluation report (super report). The super report may have a filter that may specify the type of date range a user would like to look at (e.g., 1 week, 1 month, 3 months, 6 months, 12 months, etc.). The super report may also have a drop down to specify a view. For example, an admin view may be only available to data management center employees, a company view may be only available to users associated with a particular entity (e.g., company), a facility view may be available to all those who have access to reports. The company and admin view may include a list of facilities with the buckets across the top and a summary at the bottom. The facility names can be clicked on and take the user to the facility view. Thus, different users may have different levels of access, or may have access to certain parts of reports, or certain reports. Alternatively, some users may have access to all parts of the laboratory data management software. The end date may also be selectable.

The super report may be directed to a facility, or any other level. The report may include information about cancelled or compromised tests. A graph may display information about cancellation distribution. Examples of errors or compromises that may occur could include: tubes received with no order, no samples received, unspun specimens, poorly spun specimens, hemolyzed specimens, clotted specimens, unlabeled specimens from a known facility, mislabeled specimens, wrong collection date, QNS, old specimens, incorrect packing or shipping procedures, or collection errors. The report may be drillable, so that clicking on an item drills in to see the patients making up that item, clicking on a patient drills in further to the inquiry for the patient selected.

Patient Detail

As previously discussed, a report may enable a user to select a portion of the report to access additional data. For example, a user may click on the report to get individual patient level data. As shown in FIG. 5A, certain areas, such as a graph, may be clickable to get patient detail.

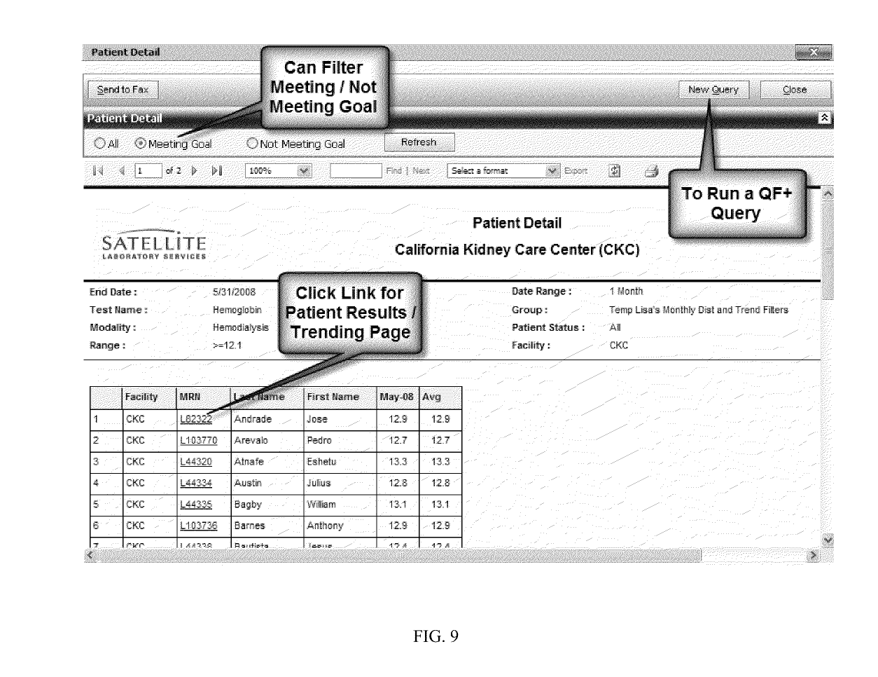

FIG. 9 provides an example of a patient detail list page. In some embodiments, a list of patients meeting one or more criteria may be provided. Summary information associated with each of the patients may be provided (e.g., facility, MRN, name, data at a particular time, average data).

A user interface may include selections that the user may make for the criteria to generate the patient list. For example, all patients may be listed, or patients meeting a goal or not meeting a goal may be listed. Thus, a patient list may be filtered depending on whether the patient meets a goal. Other criteria may be provided (based on date, facility, patient personal info, patient data, etc.). In some embodiments, default criteria may be preset. For example, default criteria may be preset depending on how the user navigated into the patient detail list page. For example, if a user came from a report, and selected a particular distribution from the report, the patients listed in the patient list page may be from the particular distribution selected from the report. Similarly, if a user came from a report page and had selected a particular test, the patient list page may only include patients with that particular test.

A user may click on a link for a particular patient from the patient list to view additional details about the particular patient. Such details may include patient results and trending.

Patient Inquiry

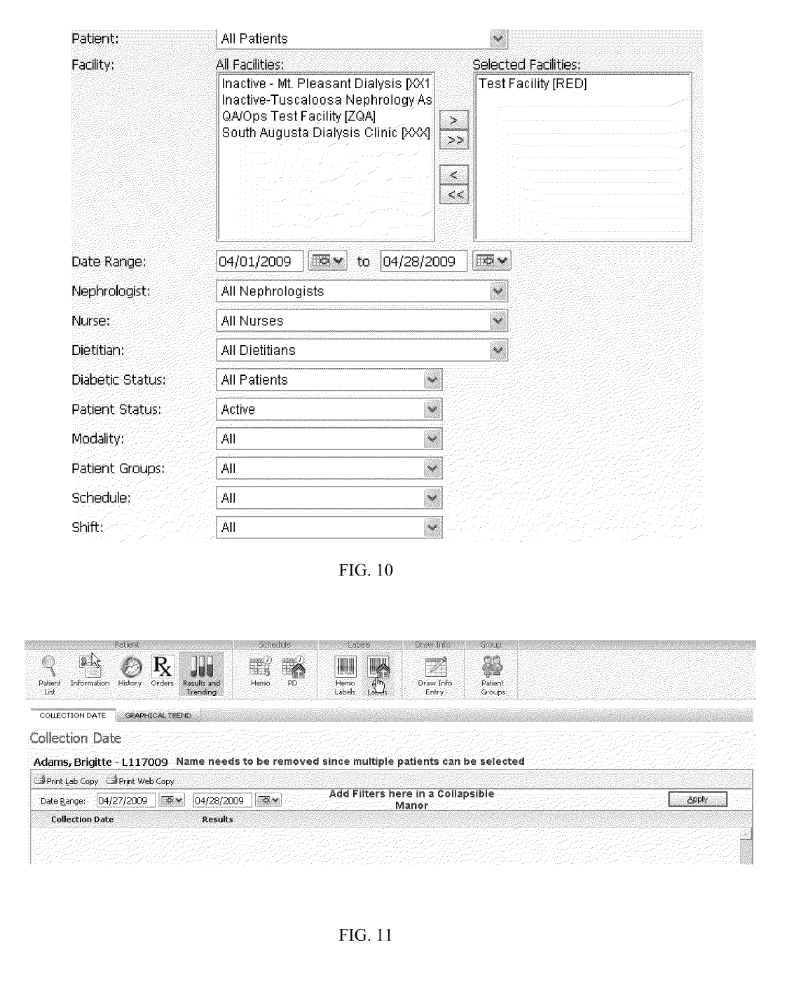

In some embodiments, a user may search patients based on any number of factors. For example, as shown in FIG. 10, a group of patients may be searched. For example, a group of patients may be defaulted as all patients, or may have a group that may be a subset of all patients. The patients may also be filtered by facility. For example, a user may select a facility from a list of facilities. Patients may also be searched by date range. A starting and/or ending date may be provided for the date range. A patient may also be searched by nephrologist, nurse, dietitian, diabetic status, patient status, modality, patient group, schedule or shift. The default value for any of these parameters may be to be inclusive of all. After a user has selected the desired parameters, the user may search for the patients that meet the selected criteria. In some instances, a list may be generated with the results.

FIG. 11 provides an example of a patient that may be provided as a result of a patient inquiry. Thus, medical laboratory data (which may be associated with a patient) may be analyzed based on a selected focus criteria. Some examples of the selected focus criteria include at least one of the following: schedule, days in dialysis, age, gender, nephrologist, race, diabetic status, or facility. The selected focus criteria may include any of the possible search parameters for a patient.

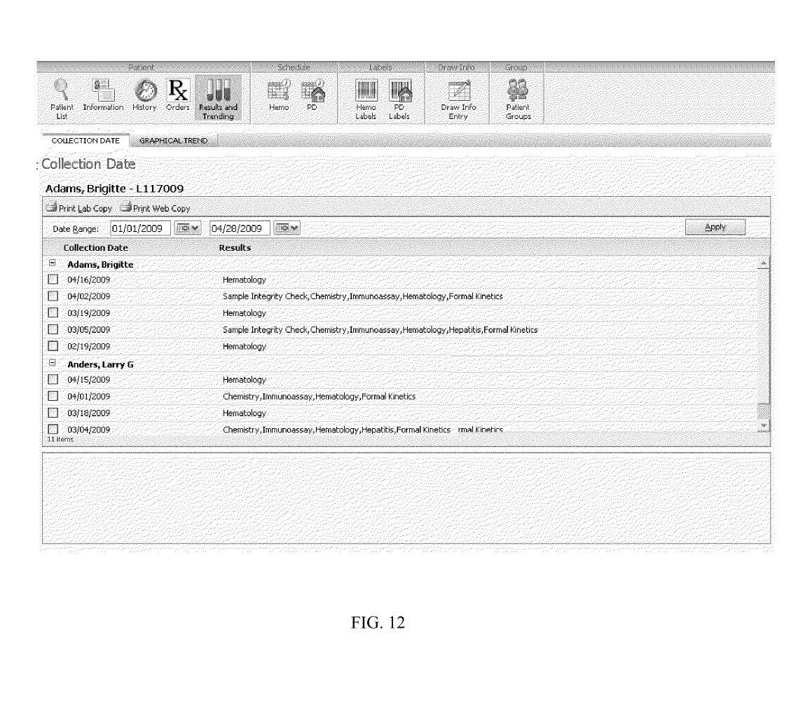

FIG. 12 shows an example of a list of patients that may be provided as a result of a patient inquiry. For example, one or more patients may be displayed. A patient's name may be provided along with various results for the patient. A user may be able to select a particular result. In some embodiments, the list of patient names may be expandable and collapsible so that a user may or may not view the various results for each patient.

A user may be able to select a patient's name to drill down and get additional details about the patient. A user may be directed to a patient details page, or any other page showing additional details about the patient.

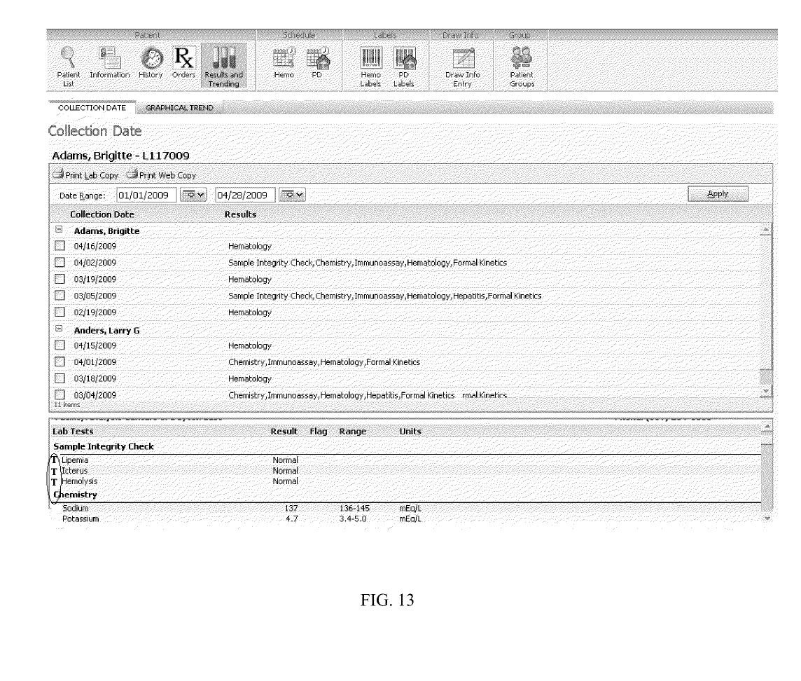

In some embodiments, a visual indicator, such as a “T” for trend (e.g., FIG. 13), may be provided beside a results name which would take a user to a graphical trend page to trend that result. This result may be automatically selected under an all results section and displayed for a particular patient.

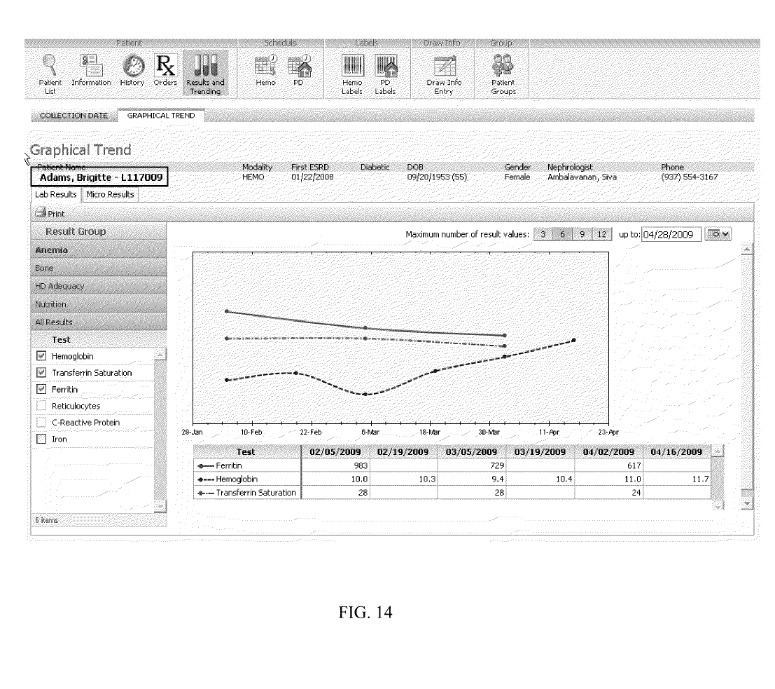

FIG. 14 shows an example of a graphical trend page. The graphical trend page may show various graphical trends for a particular selected patient. Personal information about the patient may be provided, such as the patient name, date of birth, gender, or phone number. Medical and/or laboratory related information for the patient may also be provided (e.g., modality, first ESRD, diabetic status, nephrologist, etc.). Options may be available to view lab results and/or micro results.

In a lab results view, a user may be able to select a results group (e.g., anemia, bone, HD adequacy, nutrition, or all results), and from a results group, a user may select one or more test. The selected tests may be displayed as a graph showing the trends. Any type of graph may be used (e.g., line, bar, pie, etc.). In one example, the tests are shown in a line graph with a separate line for each test. A chart or table with relevant values for the tests may also be displayed. A user may be able to control the maximum number of result values shown on the graph (e.g., 3, 6, 9, or 12) or maximum time period covered up to a particular date.

In some embodiments, the patient name may be available as a drop down list so that a user can move between patients. In some embodiments, any other navigational feature may be provided. For example, the various patient names may be visible for the user to select from, or a forward or back arrow may enable a user to navigate directly between patients in a list, or a navigational bar may be used to enable a user to select a patient.

Groups

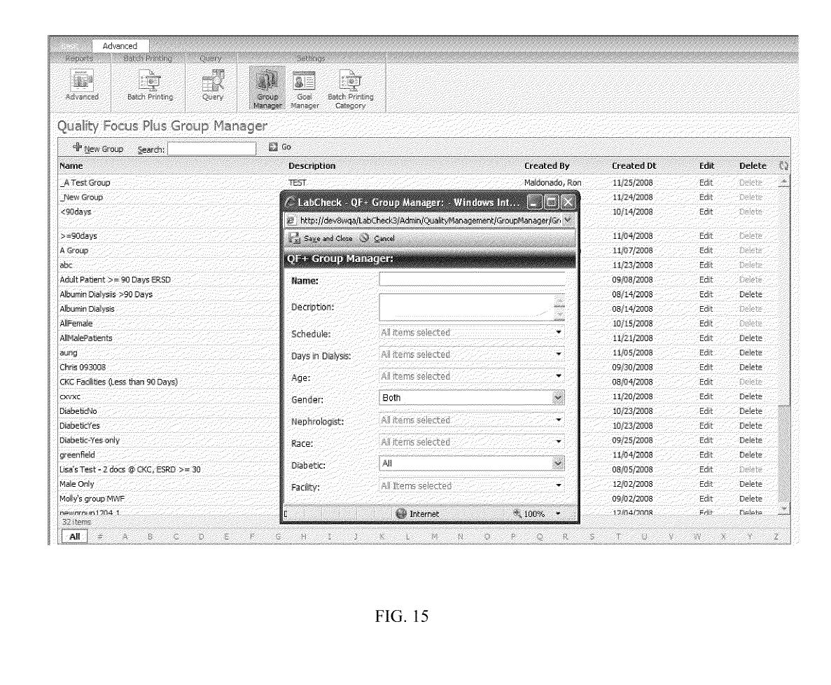

FIG. 15 shows a group manager page. The group manager page may be used to create and manage patient groupings using filters. Some examples of filters may include schedule, days in dialysis (e.g., ESRD date<90 days or >=9 days), age, gender, nephrologist, race, diabetic status, or facility. The group manager page may include a list of existing groups. Such information may include a group name, a description of the group, who created the group, a creation date, and actions that may be taken for a group (e.g., edit or delete). In some embodiments, when a group has been used in a report, its delete function may be disabled.

A user may create a new group. When creating a new group, a user may enter a group name, description, schedule, days in dialysis, age, gender, nephrologist, race, diabetic, and facility. In some embodiments, a patient list generated from a patient inquiry searched by various parameters may be stored as a group. Fields may be used later as filters to help manage the group. In some instances, required fields may be visually emphasized (e.g., bolded or highlighted). In some instances, selecting an option to edit a group may bring up a similar interface to creating a new group. When editing an interface, the fields with values may already be populated, and a user may modify the values.

A group may be one way of gaining access to a patient list. For example, when a particular group is selected, a patient list may be displayed with all of the patients belonging to the group. Then, the patient list may be further filtered as desired. A group may be dynamic or static. For example, a dynamic group may have members that may change, as the member details change so that they do or do not meet the criteria of the group. For example, over time a patient's age will change, so that a patient may leave the age range provided in the group. In such a situation, the patient may be removed from the dynamic group. A static group may keep the same patients that met the criteria at the time the group was created.

Goals

Goals may be provided for a patient, group, facility, or entity. For instance, there can be system goals, company goals, or facility goals. Such goals may relate to medical data, such as renal data. For example, a facility may set goals for particular tests. Thus, a facility may have one, two, or more laboratory result goals. The goals may be reference laboratory facility data that may be compared to with an actual laboratory facility data. Alternatively, goals may also be connected to any other laboratory data, which may include financial data.

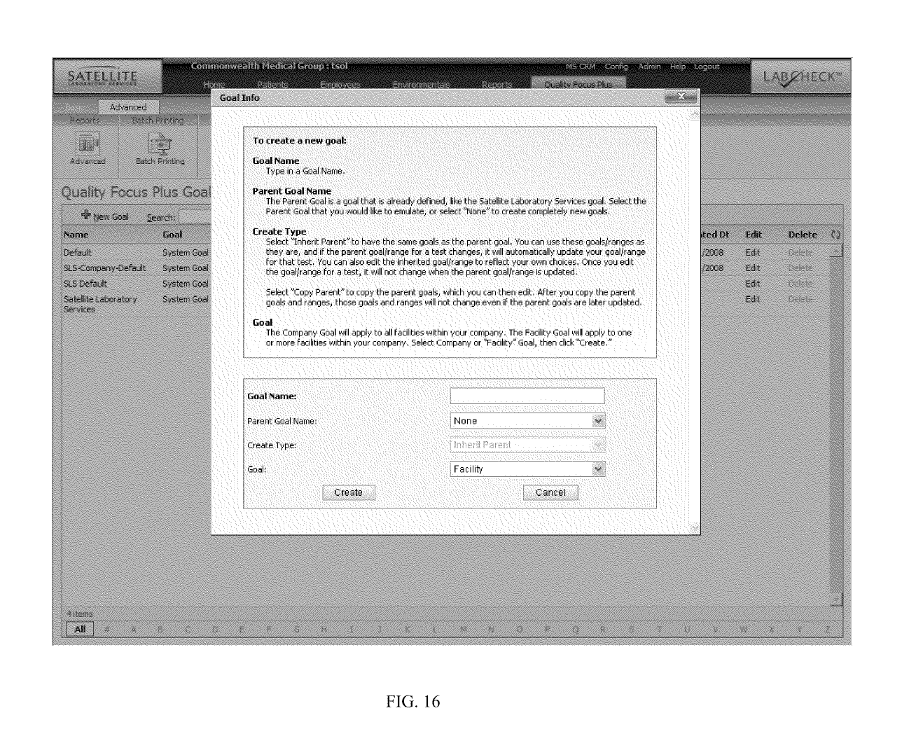

FIG. 16 shows a user interface for creating a new goal. An interface for creating a new goal may provide instructions for providing the goal. A user may enter a goal name, and may determine whether there is a parent goal name, select a type of goal, and specify the level of goal (e.g., system, company, facility). In one example, a goal applying to a company, may be applied to all facilities associated with the company. A goal applying to an entire system may apply to all of the facilities interacting with the data management center. The user may be affiliated with a facility or with a company, so that a laboratory facility or an entity affiliated with the at laboratory facility may define its own goal.

A parent goal may be an existing goal that the new goal would emulate. In some embodiments, a parent goal may be selected from a group of existing goals, a parent goal name may be typed in, or no parent goal may be selected. A goal type may indicate how a goal may change. For example, if the goal type is set to ‘inherit parent’, the new goal will have the same goals as the parent goals. If the parent goals change, it will automatically update the new goal. In some embodiments, if a parent is inherited, the parent may not be deleted unless all child goals are also deleted. In another example, if the goal type is set to ‘copy parent’, the new goal will initially have the same goals as the parent goals, but if the parent goals change, the new goals will not be automatically updated.

In some embodiments, a graphical user interface may be provided for facility performance assessment. The graphical user interface may have a list of a plurality of lab result types. The user interface may also show a plurality of comparison methods, where each comparison method may be visually mapped to the corresponding laboratory result type. The user interface may also include a plurality of goal values, where each goal value may be visually mapped to the corresponding laboratory result type. Additionally, the user interface may show a plurality of acceptable range values, where the acceptable range values may denote an acceptable range for a laboratory result type. The visual mapping may indicate that the items are displayed within the same column, row, or region, or are somehow otherwise visually associated with one another.

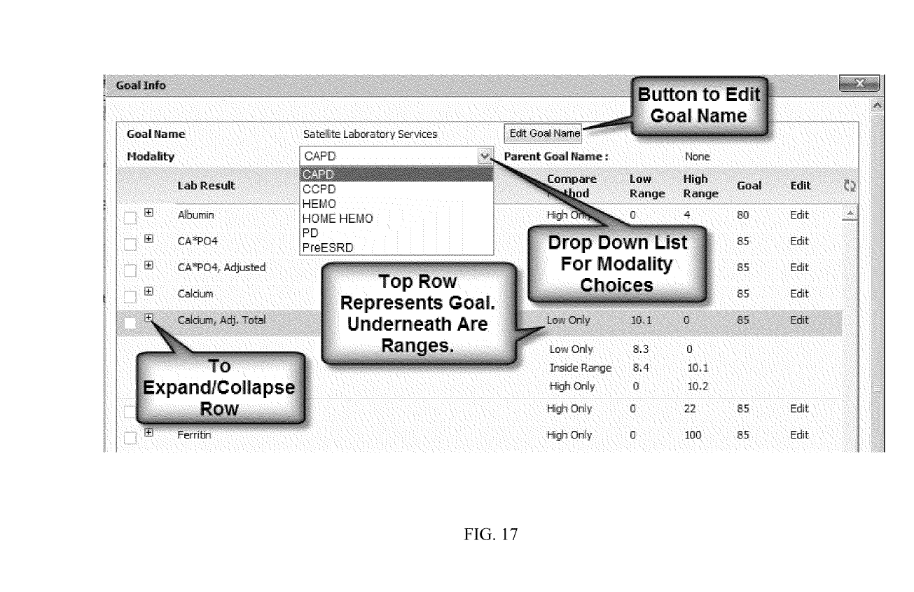

FIG. 17 shows an example of a goal manager. A goal manager may be an area to set goals and ranges for reports. In some embodiments, a goal manager may enable a user to select a lab result. The lab results may be listed in any manner (in some embodiments, they may be provided as a list or nested list). A goal may be set for the selected lab results. Each lab result may have a comparison method. A goal may be set for each lab result, and a low range and/or high range may be provided for the goal. The range settings may be inclusive and the comparison methods can be inside, outside, high or low. By having a comparison method or a range setting, an acceptable range of values for a lab result may be provided. Thus, in order to meet a goal, a lab result need not have exactly the same value as the goal, but may fall within an acceptable range of the goal (whether that acceptable range be closed on both sides, or open on one side). Goal information may be auto-saved. Each of the goals provided may be edited.

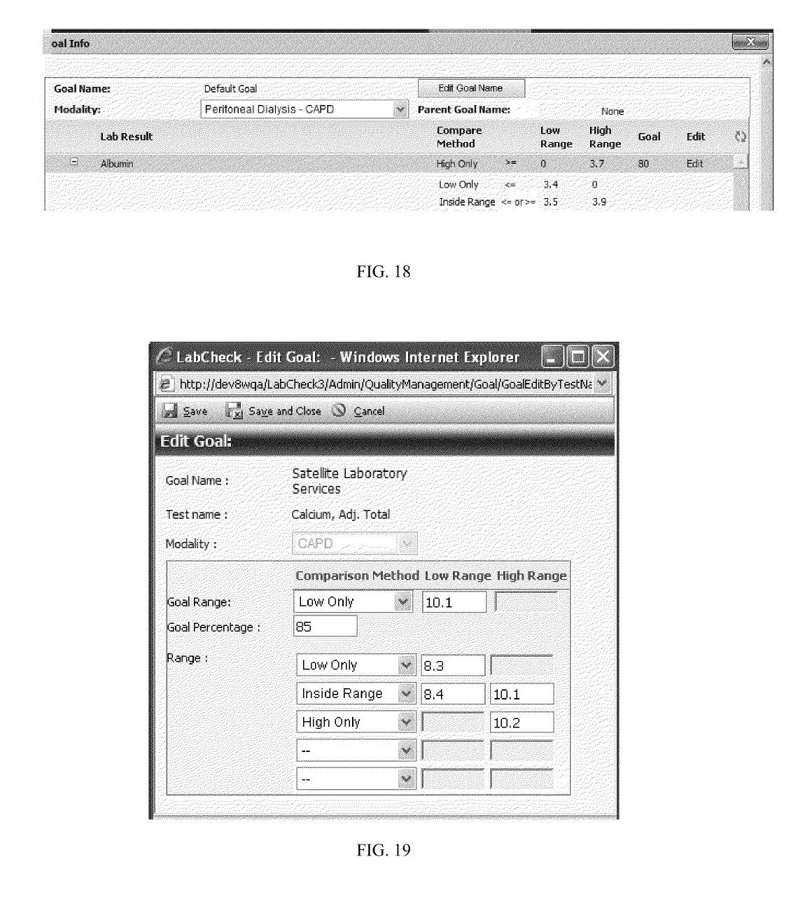

FIG. 18 provides an example of an expanded view of a goal for a particular test. In some instances, a goal manager may enable a user to collapse or expand a particular test goal. The expanded goal may show information about all of the applicable comparison methods, as well as a low range, high range and/or goal.

FIG. 19 provides a user interface for editing a goal. The goal editing interface may be accessed from a goal manager. For example, editing a goal may open up the goal editing user interface. The goal editing user interface may be provided as a popup, or may appear adjacent to or over the goal manager screen.

A goal for a particular test may be provided (e.g., Calcium, Adj. Total). A comparison method may be set for the goal range, and a low or high range may be provided. In some instances, a user may only set a low or high range if it matches the comparison method. For example, if the comparison method is low only, then only a low range may be specified. A goal percentage may also be set. A goal editing screen may also include ranges, which may include a comparison method, and a low and/or high range for each comparison method provided.

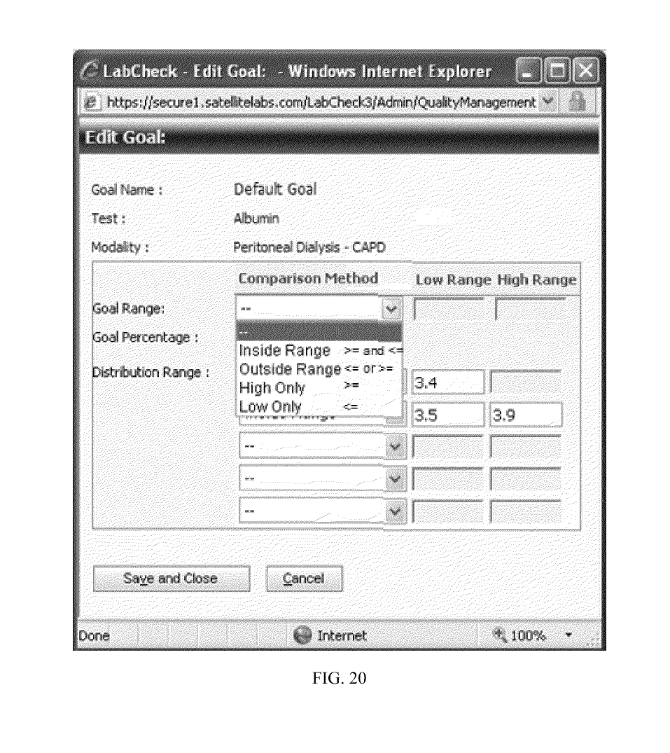

FIG. 20 shows an additional view of a goal editing interface. A drop down menu may be provided for a comparison method. The drop down menu may list the available options for comparison method, such as inside range, outside range, high only, or low only. In alternate embodiments, other user interactive interfaces may be provided to enable a user to select a comparison method. For example, a user may be able to select a button with a comparison method, check a box, or type the name of the comparison method into a field.

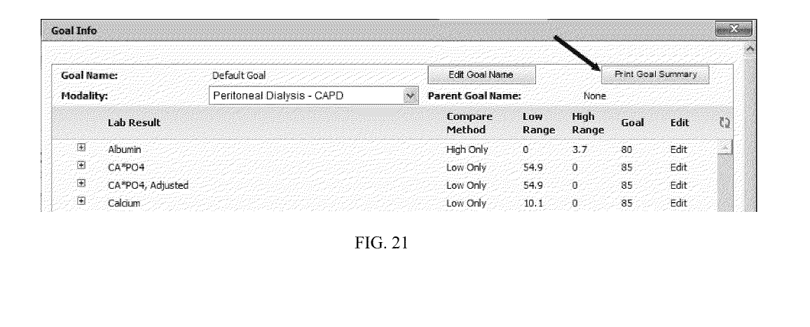

FIG. 21 shows a goal manager interface which may also include an option to print a goal summary.

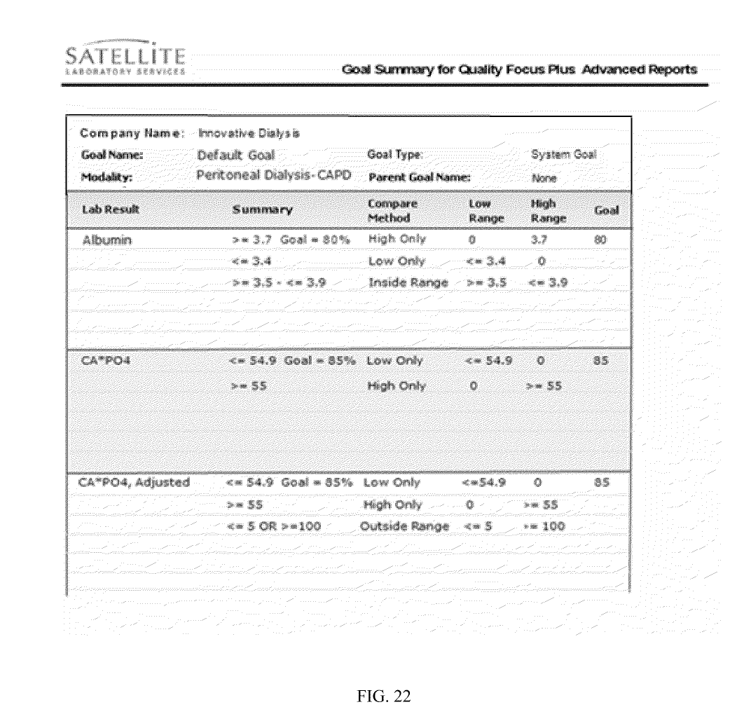

FIG. 22 shows an example of a goal summary that may be printed. The goal summary may show all of the various tests that may have goals. In some embodiments, the goal summary may also include tests that don't have goals. The goal summary may show the lab result name, a summary of the goal, a comparison method, a low and/or high range, and a goal value. A goal summary may be provided for a facility, an entity, or a system.

Report Copying

Users may copy any reports from one facility to another. External users may somehow be affiliated with a laboratory facility and/or an entity associated with a laboratory facility. Internal users may somehow be affiliated with a data management center.

External users with the appropriate access can create reports and copy them to multiple facilities to which they have access within their own company. In some embodiments, external users may be able to see the listing of report templates within their own company. However they are only able to copy a report into only the facilities that they have access. The list of facility choices in the 2^{nd} step of the UI will be limited to the user's access of facilities. For example, a user from a particular entity associated with a plurality of facilities may be able to copy reports between the facilities they are associated with. Examples of external users may include Company Administrators, Corporate Report Users, both types of Head Nurses, and any users with feature role of Report Template Copiers.

For internal users, they can copy reports from one company to another, thereby saving time and effort when sharing templates between clients. Examples of internal users may be users accessing the laboratory data management software from a data management center. For example, internal users may be employees or otherwise associated or affiliated with the data management center, which may interact with a plurality of facilities. Internal users may have access to all companies and all facilities. Examples of internal user types may include System Administrators, CS Representatives, or Sales Representatives.

In various alternative implementations, patients may have access to a laboratory data management software. They may be able to access limited functionality of the software. For example, they may only be able to view and/or copy particular reports.

In some embodiments, when a report is copied, the report name may generally default to “Copy of . . . ” with the user's ability to edit the name during the process. This may be similar to copying other reports like custom/report cards, etc. Report Description, Test name, Modality, Date range, Calculation method, Patient status, Lock report selection, and Runtime Prompt selection(s) or other features may copy over as is per original report configuration. For a Rolling Detail report, “Include Physician”, Comparison criteria and values, and the Inclusive checkbox will also copy over per original report configuration.

Report goals may also be copied from one facility to another. Reports with a default goal from a data management center can be copied to any facility globally. Reports with a company (or other entity) goal can be copied between facilities within a company. Copying an intracompany report with a facility goal or copying an intercompany report with a company or a facility goal may cause the copied report to default to “No Goal Selected” with a runtime prompt is selected. A message may be provided that informs users of this detail during copy process, or that informs users of any other copying defaults or policies.

Other default values may be provided. For example, any report with a group in the template may default to “No Group Selected”. If the original report template has a group attached, a message could inform user as such. In another example, all copied reports may default to “0 Items selected”.

Various dimensions of a report may copy over. For example, most of the dimensions in an original report can be copied. In some embodiments, some dimensions may not be copied, e.g., facility and nephrologist. In one example, if the original report has dimensions of Days in Dialysis, Schedule, Gender, Patient Age, Race, or Diabetic, then that selection should copy over for the new report. For dimensions that may not copy over (e.g., Facility and Nephrologist), when copying a report from one company to another company, a default may be provided to that same selection but have the value of the dimension as “0 Items selected” and runtime prompt checked, or have some other null value. There could be a message that informs users of this detail during copy process. For dimensions that do not copy over (e.g., Facility and Nephrologist), when copying within the same company, the values for such dimensions can stay the same. The user's individual facility access(es) may determine whether the report can be rendered or not. For example, if report is for a facility to which the user does not have access, or if the report is for a Nephrologist belonging to a facility that user does not have access, then the report would be blank.

Similarly, selected Filters can copy without problems like Age, Days in Dialysis, Diabetic Status, Gender, Race, and Schedule. This may be the case when copying within the same company or copying to another company. If a filter that may have trouble copying (e.g., Nephrologist and/or Facility) are chosen in original report, it could default to “All” when copying to another facility. There could be a message that informs users of this detail during copy process.

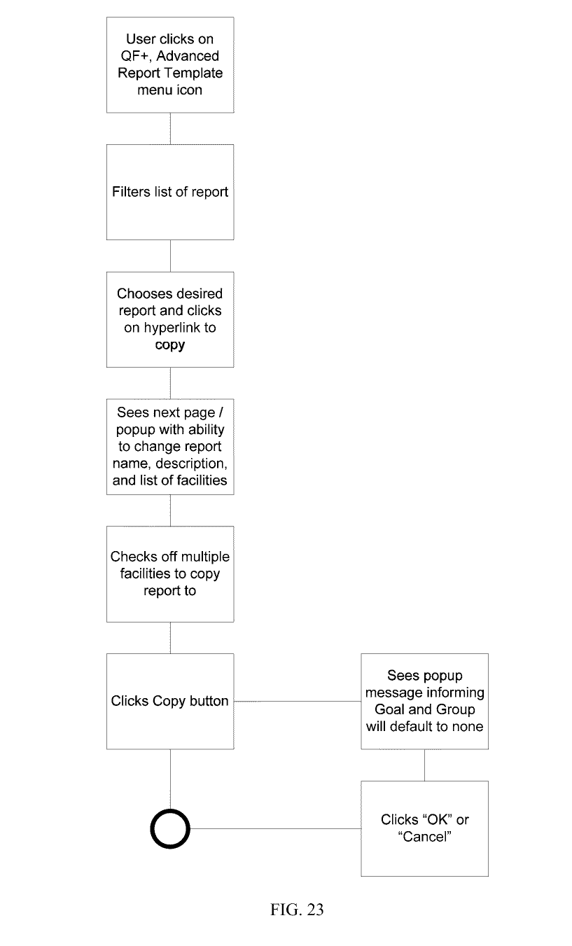

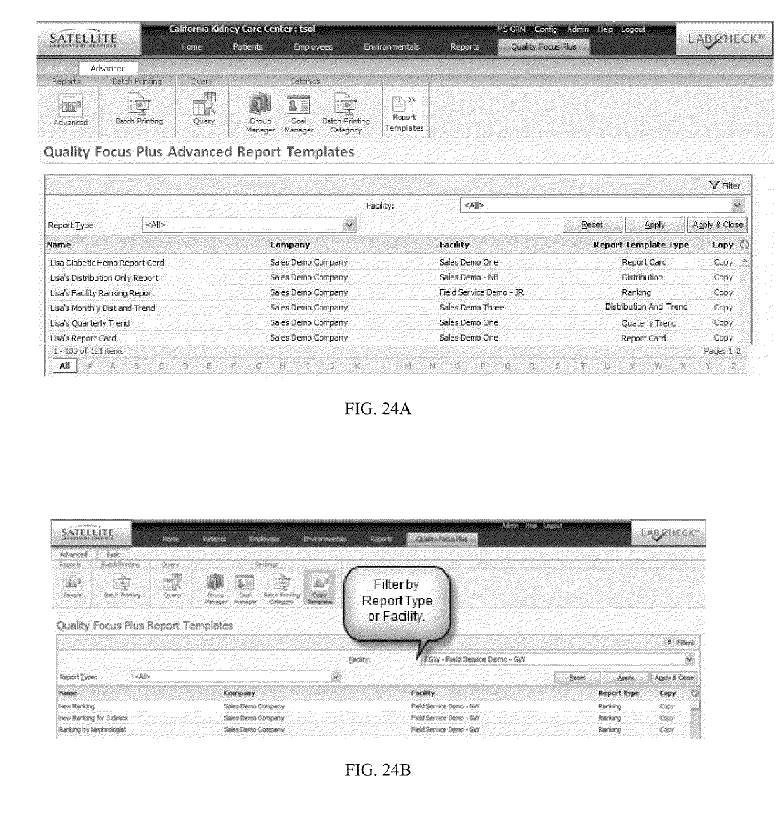

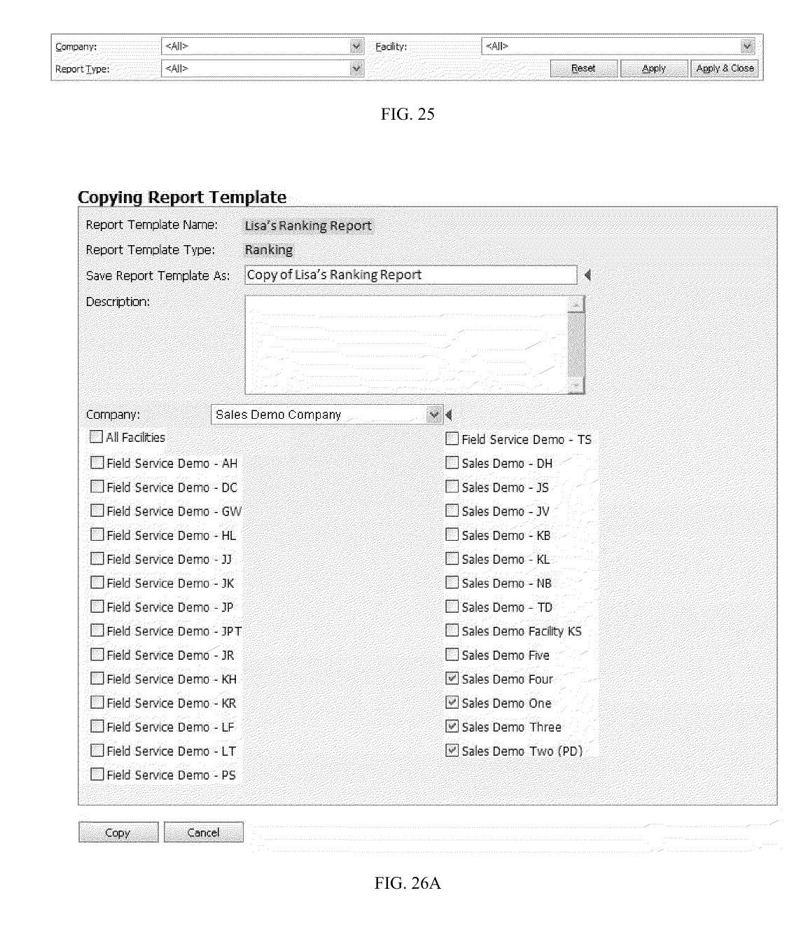

FIG. 23 shows an example of a work flow process when a user is copying a report from one facility to another facility. For example, a user may select a report template menu icon. A list of reports may be filtered and provided to the user to select from (see, e.g., FIG. 24A, FIG. 24B). For example, the list of reports may be filtered by parameters, such as facility, or report type. In some embodiments, external users may have limited filtering options. The report may also be filtered by company (see, e.g., FIG. 25). In some embodiments, external users may have the option of filtering by company, while in some instances internal users may not. Depending on user type or status, a user may be able to access different report filtering options. The user may choose a desired report and clink on a hyperlink (or in some other manner select the desired report) to copy the report. A user may be directed to a next page which may include display with the ability to change certain details about the report. The display may be a popup, another screen, or another window. A user may change details including, but not limited to, report name, description, and list of facilities.

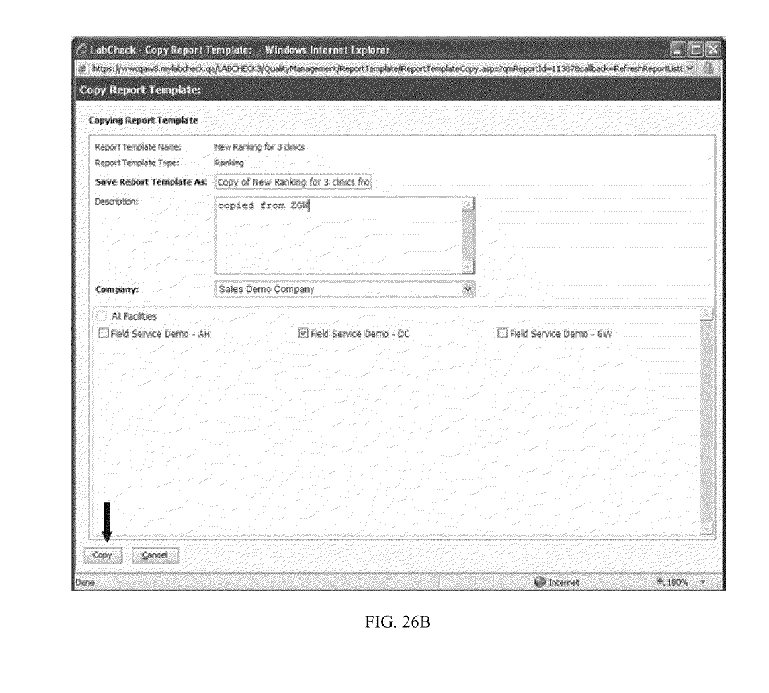

The user may then select the facilities to copy the selected report to. A user may select one, two, or more facilities to copy the report to. In some embodiments, a list of available facilities may be provided and the user may check of the facilities to copy the report to. In some embodiments, depending on the user and the user access permissions, the available facilities may be facilities associated with the same company or entity, or may include all of the facilities serviced by a data management center. The user may then select a ‘copy’ button to copy over the report to the selected facilities. In some embodiments, a user may see a message informing the user that a goal and/or group value may default to none. At that time, the user can decide to continue copying the report or cancel. FIG. 26A provides an example of a copying report template, where a user may save a report template, provide a report template name and description, select a company, and select facilities to copy a report to. FIG. 26B provides another example of a copying report template.

In some embodiments, a user may select more than one report to copy at a time. The user may set the desired characteristics or parameters for each of the reports that the user is copying. After the desired reports and facilities have been selected, the user may select a copy option, which may copy all of the selected reports to each of the selected facilities.

Bundling Analytics

A laboratory data management software may also include options for a financial tool, such as bundling analytics. For example, reports may be provided that may summarize the cost per patient that a company or facility may be responsible for once Medicare bundling goes into effect. Medicare bundling may group particular tests together and require costs for the tests all together. Furthermore, the financial reports may give users the ability to compare their laboratory testing utilizations to other facilities.

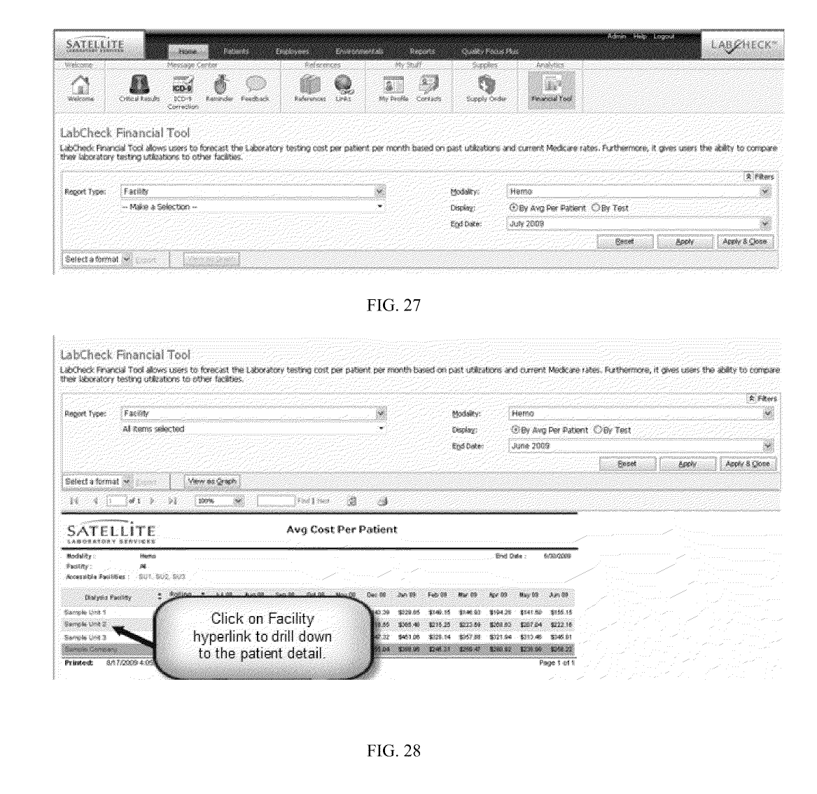

A financial tool may be selected in the following manner. FIG. 27 shows that a financial tool may be selected from a menu. Report parameters may be selected. For example, a region type may be selected (which may be based on a user's access). For example, a region type may be a facility or a company. Another report parameter may be selecting a facility or nephrologist. In some embodiments, a user may also be able to select a modality, a display (e.g. by average per patient, or by test), and select an end date. In some embodiments, the range of time shown by the report may be fixed or variable. For example, a default range may be for the past 12 months of data. Otherwise, a user may select the range of data to be displayed. The user may click apply to run the report, which may be displayed in a table format.

FIG. 28 shows an example of a report. The report may have fields where a user may vary the parameters. A user may be able to drill down further from the report by clicking on selected portions. For example, a user may be able to flick on a facility name or a nephrologist to drill in to patient detail. A user may be able to view actual patient costs and/or test results from the patient detail. In some instances, a user may be able to access average patient information (financial and/or medical) for a particular facility or nephrologist. A user may also export the report by selecting an export option. The report may be exported in different formats, e.g., excel or pdf. A user may also select an option to print report, or to view the report as a graph.

Different views may be offered in a bundling analytics report. For example, the following views may be provided:
Company View—List all facilities and the Average Cost per month of each facility with the highest at the top and a company average at the bottom
Facility View—List the Average cost per month per patient for 12 rolling months and an average cost for all 12 months for a single facility
Physician View—List the Average cost per month per patient for 12 rolling months and an average cost for all 12 months for a single Physician
Test View—Count of each tests preformed per month with cost and avg cost per patient, with views for Company, Facility, or Physician.

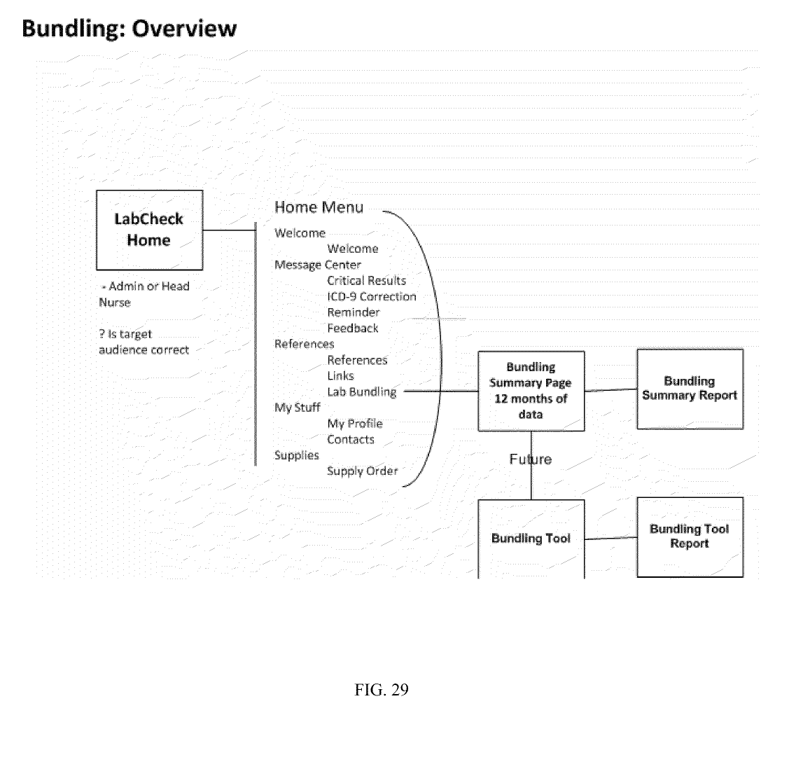

FIG. 29 provides an overview of a financial tool. For example, a laboratory data management software home may be provided. This may be accessed by a user, such as an admin or a head nurse. The software may have a home menu. Some of the sections provided in the home menu may be a welcome section, a message center (e.g., with critical results, ICD-9 correction, a reminder, or feedback), a references section (e.g., with references, link, lab bundling), a my stuff section (e.g., with a user profile and contacts), and a supplies section (e.g., with supply order).

A bundling summary page may be accessible from another page, such as a lab bundling page. The bundling summary page may access data from a specified period of time. In some embodiments, the period of time may be fixed, or may be variable. In some instances, the user may be able to select the period of time. A default period of time may be provided. In some embodiments, the period of time may be for 12 months, although other time periods, such as 1 week, 1 month, 3 months, 6 months, 9 months, 2 years, or 5 years may also be provided. A bundling summary page may provide a user with access to a bundling summary report and a bundling summary tool, which may also provide access to a bundling tool report.

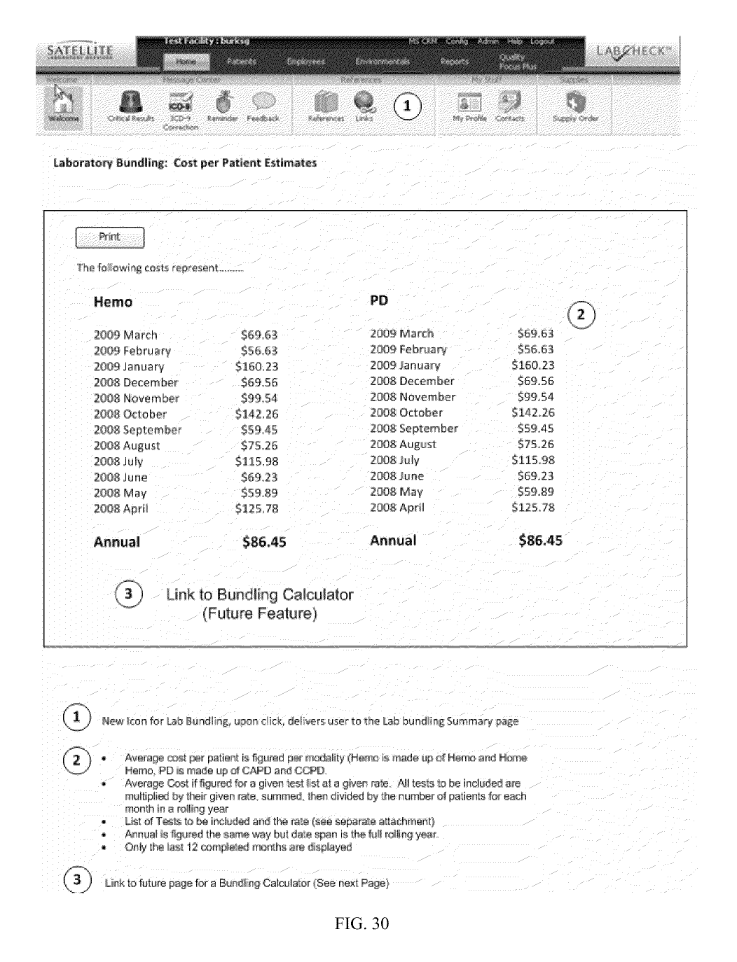

FIG. 30 shows an example of a laboratory bundling page. The laboratory bundling page may include cost per patient estimates. Estimated costs per patient for different modalities may be provided (e.g., Hemo and PD). For example, a Hemo modality may be made up of Hemo and Home Hemo, while a PD modality may be made up of CAPD and CCPD. The costs may be broken down by time periods. For example, estimated average costs per month, based on the past 12 months may be provided. The average cost may be figured for a given test list at a given rate. All tests to be included may be multiplied by their given rate, summed, then divided by the number of patients for each month in a rolling year (or other time period).

In some embodiments, a list of tests may be included, along with a rate for the tests. The annual value may be figured in the same way as the per month values, but the date span may be for the full rolling year. Only the last 12 months (or other selected time period) may be displayed.

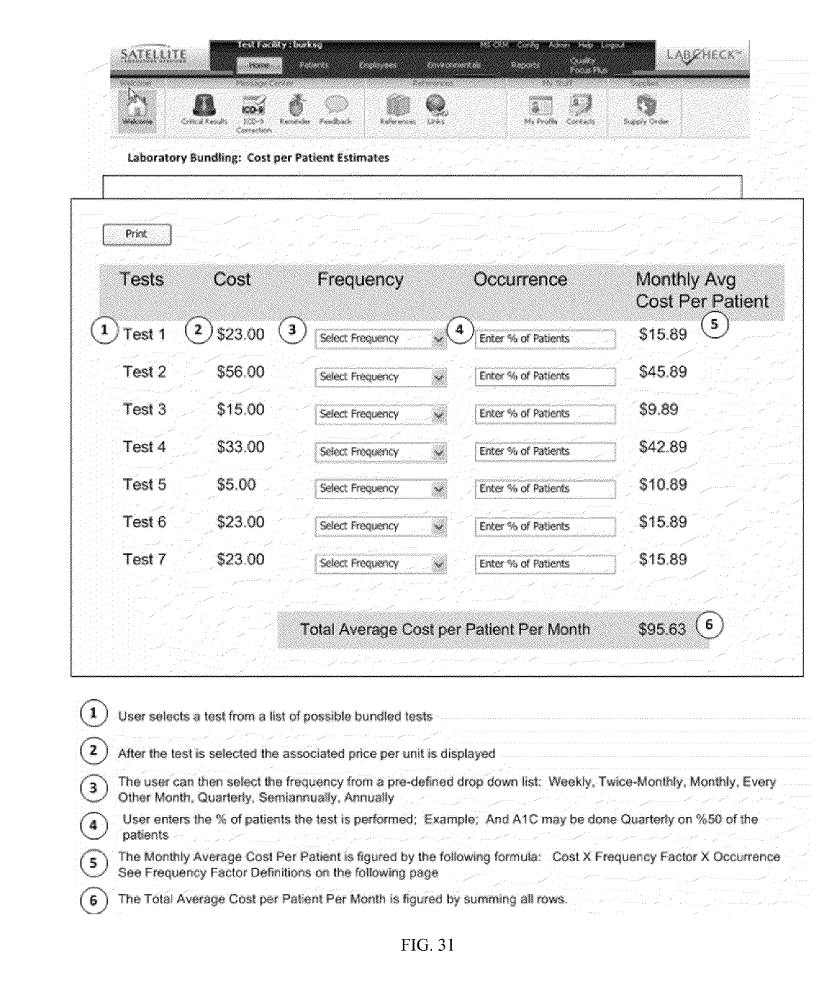

The user interface may also provide a link to a bundling calculator page. FIG. 31 shows an example of a bundling calculator page. The bundling calculator page may list various tests (e.g., Test 1, Test 2, Test 3, Test 4, Test 5, Test 6, Test 7) that may be possible bundled tests. After the test is selected, an associated price per unit is displayed (e.g., $23.00 for test 1). The user may then select a test frequency from a drop down menu, or any other user interactive interface (e.g., from a series of buttons, from a series of check boxes, entering frequency value into a field, etc.). The drop down menu may have pre-defined test frequencies, such as: daily, weekly, twice-monthly, monthly, every other month, quarterly, semiannually, or annually. Any other time period may be used for a test frequency.

The user may then select an occurrence, which may be the percentage of patients for which the test is performed. For example, a particular test may usually be performed on about 50% of the patients. Thus, at this point, a user may have that Test 1 may be done quarterly on 50% of the patients. The bundling calculator may then determine the monthly average cost per patient for the selected test. The following formula may be used:

cost×frequency factor×occurrence=monthly average cost per patient

For example, the cost for Test 1 ($23.00) may be multiplied by a frequency factor value (e.g., 0.333 for a quarterly test), and multiplied by an occurrence (e.g., 0.5 for 50%) to yield a monthly average cost per patient. A total average cost per patient per month may be calculated by summing all the values for the monthly average cost per patient for each of the tests selected.

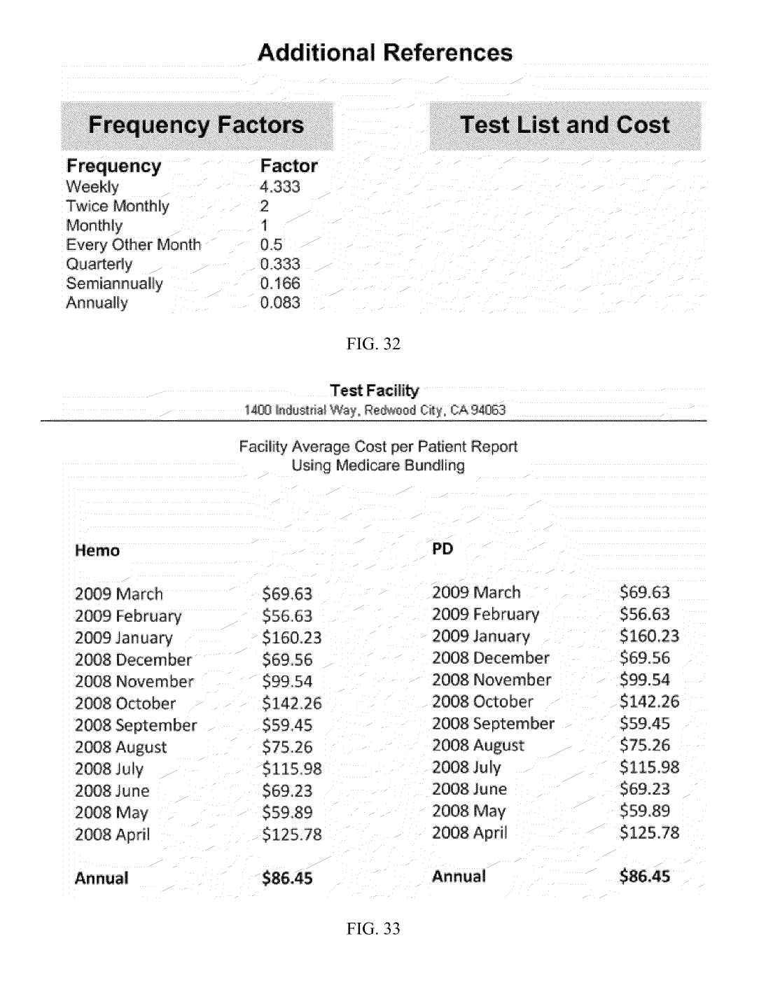

FIG. 32 shows an example of frequency factor values that may be provided for given frequencies. For example, if a test is performed weekly, the frequency factor may be 4.333. Similarly, if a test is performed twice monthly, the frequency factor may be 2. The frequency factors may be based on a time period for which the average cost per patient is being calculated. In the example provided in FIG. 31, the time period may be a month. Thus, the frequency factor may be calculated as follows:

frequency factor=(length of month/length of time in the frequency period)

In one example, a month may be about 30 days, and the length of time in a frequency period of every other month may be about 60 days, so that the frequency factor may be about 30/60=0.5.

In some embodiments, the time period for which the average cost per patient is being calculated may be varied. For example, rather than calculating the cost every month, the cost may be calculated every quarter. In such a situation, the frequency factor may be generalized as:

frequency factor=(length of time period/length of time in the frequency period)

For example, if the time period is a quarter, and the frequency period is also every quarter, then the new frequency factor will be 1.

FIG. 33 shows an example of a facility average cost per patient report using Medicare bundling. The report may be divided by modalities (e.g., Hemo and PD). The average cost per patient for each time period (e.g., a month in this case) may be provided, as well as a total average cost per patient over a longer time period (e.g., a year in this case). Different shorter time periods or longer time periods may be provided. In some instances, a user may select the shorter and/or longer time period.

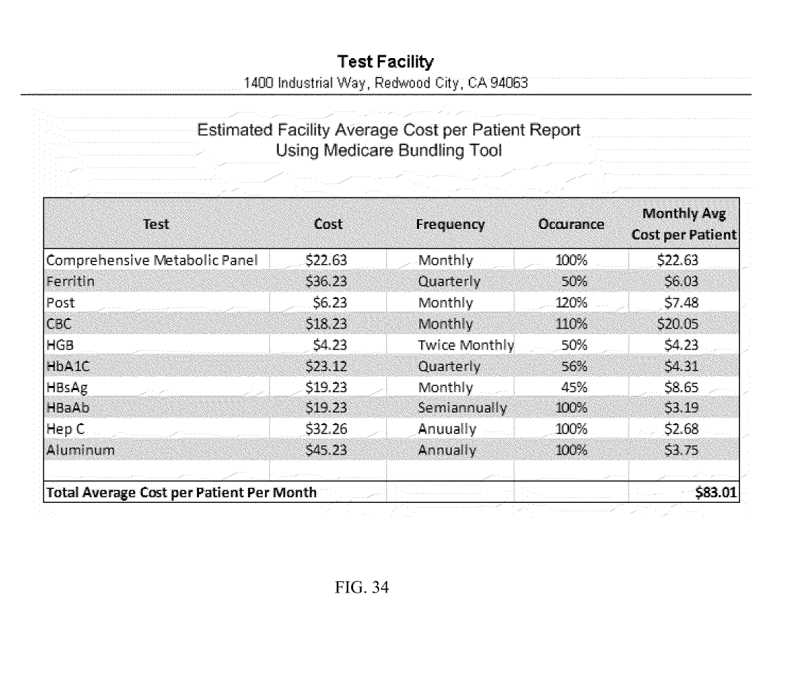

FIG. 34 provides an estimated facility average cost per patient report. This report may show the various tests selected (e.g., comprehensive metabolic panel, ferritin, post, CBC, HGB, HbA1C, HBsAg, HBaAb, Hep C, Aluminum). The cost for each of these tests may be provided. Similarly, the frequency for each of these tests may be provided (e.g., daily, weekly, twice monthly, monthly, every other month, quarterly, semiannually, annually). The occurrence for each of the tests may be provided. Then the monthly (or other time period) average cost per patient may be calculated by the financial tool and provided.

In some embodiments, the report may be arranged so that the tests are arranged in a horizontal or vertical list. Each test may be visually mapped (e.g., in the same row or column) with its associated cost, frequency, occurrence, and monthly average cost per patient. The total average cost per patient per month may be provided as a sum of the monthly average cost per patient for each test.

The financial viability for a laboratory to perform particular bundled tests in view of Medicare bundling may be analyzed. Based on estimated or actual costs associated with the bundled tests and based on Medicare payments, a lab may determine whether the lab will offer the bundled tests.

A laboratory data management software and/or systems and methods for monitoring or reporting laboratory data may incorporate any of features, characteristics, components, or steps as known in the art. See, e.g., U.S. Patent Publication No. 2004/0111293; U.S. Pat. No. 4,315,309; U.S. Pat. No. 7,433,827; U.S. Patent Publication No. 2005/0203777; U.S. Patent Publication No. 2008/0046286; U.S. Patent Publication No. 2009/0094058; and U.S. Patent Publication No. 2005/0171801, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A system for managing medical laboratory data, said system comprising:
a telecommunications network;
at least one remote laboratory facility with laboratory equipment for gathering medical laboratory data from a plurality of subjects; and
a data management center for receiving medical laboratory data from the at least one remote laboratory facility via the telecommunications network, wherein the data management center compares the received medical laboratory data to a reference medical laboratory data to assess performance of the at least one remote laboratory facility.

2. The system of claim 1, wherein the medical laboratory data includes renal or dialysis data from the plurality of subjects.

3. The system of claim 1, wherein the reference medical laboratory data is based on at least one of the following: another laboratory facility, a mathematical calculation from the data management center based on a plurality of laboratory facilities, or generated theoretical reference data from the data management center.

4. The system of claim 1, wherein the data management center generates a report based on the comparison of the received medical laboratory data with the reference medical laboratory data.

5. The system of claim 4, wherein the report content and/or format is customized by a user of the system.

6. The system of claim 5, wherein the user chooses a report template and one or more report parameters.

7. The system of claim 4, wherein individual patient level data can be accessed from the report.

8. The system of claim 1, wherein the received medical laboratory data is analyzed based on a selected focus criteria.

9. The system of claim 8, wherein the selected focus criteria includes at least one of the following: schedule, days in dialysis, age, gender, nephrologist, race, diabetic status, or facility.

10. A method for managing medical laboratory data, said method comprising:
receiving medical data from at least one laboratory facility;
establishing at least one laboratory result goal for the at least one laboratory facility; and
determining, based on the medical data, whether the at least one laboratory result goal was met by the at least one laboratory facility.

11. The method of claim 10, wherein the at least one laboratory goal includes an acceptable range of values for a laboratory result from one or more subjects at the laboratory facility.

12. The method of claim 11, wherein a plurality of laboratory result goals are established for the at least one laboratory facility.

13. The method of claim 10, wherein the at least one laboratory facility or an entity affiliated with the at least one laboratory facility defines its own at least one laboratory goal.

14. The method of claim 10, wherein the medical data is received at a remote command center via a telecommunication network.

15. The method of claim 10, further comprising creating a report displaying information related to the laboratory result goal.

16. The method of claim 15, wherein the report includes distribution and trend data.

17. The method of claim 15, wherein the report can be filtered depending on whether the laboratory facility does or does not meet the at least one laboratory result goal.

18. The method of claim 10, wherein the at least one laboratory facility or an entity affiliated with the at least one laboratory facility creates and manages groupings based on at least one selected filter.

19. The method of claim 18, wherein the selected filter includes at least one of: schedule, days in dialysis, age, gender, nephrologist, race, diabetic status, or facility.

20. The method of claim 10, wherein the at least one laboratory goal is inherited from a parent entity, such that if the parent entity updates a goal, the corresponding laboratory goal is automatically updated.

21. The method of claim 10, wherein the at least one laboratory goal is copied from a parent entity, such that if the parent entity updates a goal, the corresponding laboratory goal is not automatically updated.

22. A graphical user interface for facility performance assessment, said graphical user interface comprising:
a list with a plurality of laboratory result types;
a plurality of comparison methods, wherein each comparison method is visually mapped to the corresponding laboratory result type;
a plurality of goal values, wherein each goal value is visually mapped to the corresponding laboratory result type; and
a plurality of acceptable range values, wherein the acceptable range values denote an acceptable range for a laboratory result as compared to the corresponding goal values, and wherein each acceptable range value is visually mapped to the corresponding laboratory result type.

23. The method of claim 22, further comprising at least one user interactive feature that provides access to edit at least one of: a goal value, comparison method, or acceptable range values.

24. A graphical user interface for performing bundling analytics for Medicare bundling, comprising:
a list of one or more tests to be included within a medical service bundle;
at least one cost value for the test, visually mapped to the test;
a frequency selection zone for the test, indicating how often the test is to be performed; and
an average cost per patient estimated over a selected time period.

25. The method of claim 24 further comprising an occurrence entry zone configured to indicate the percentage of patients that may utilize the associated test.
